(19) United States
(12) Patent Application Publication
(10) Pub. No.: US 2009/0014929 A1
(43) Pub. Date: Jan. 15, 2009

(54) Support element

(75) Inventors: Ernst Bock, Verl (DE); Udo Feldotto, Verl (DE)

Correspondence Address: HARNESS, DICKEY & PIERCE, P.L.C., P.O. BOX 828, BLOOMFIELD HILLS, MI, 48303, US

(73) Assignee: Spiroplex GmbH, Verl (DE)

(21) Appl. No.: 10/579,457

(22) PCT Filed: Nov. 18, 2004
(86) PCT No.: PCT/EP2004/013103

§ 371 Date: Oct. 24, 2007

(30) Foreign Application Priority Data
Nov. 18, 2003 (EP) 0326388.3
Apr. 14, 2004 (DE) 202004005844.8
Jun. 29, 2004 (DE) 202004010143.2
Jul. 3, 2004 (DE) 202004010433.4

(51) Int. Cl. F16F 1/373; A47C 23/04; F16F 1/12

(52) U.S. Cl. 267/103; 5/720; 267/179

(57) ABSTRACT

The invention relates to a support element (1), comprising a top plate (2) and a spring element (3) arranged thereon, whereby the spring element (3) has a coiled embodiment which tapers away from the top plate (2) in the form of a cone. According to the invention, a support element (1) which is both simple and economical to produce and which has a reliable application in long term use may be achieved, whereby the top plate (2) is made from plastic, the spring element (3) is made from plastic and the spring element (3) has a multiple winding embodiment.

The invention relates to a support element comprising a top plate and a spring element arranged thereon, whereby the spring element has a helical form in the shape of a cone. Furthermore, the invention relates to a spring element, a top plate and a connector for the arrangement of a functional element, in particular a support element, on a basis.

Support elements as such have been known from the state of the art. They serve for the resilient accommodation of mattresses, pads or the like, whereby they have a top plate arranged on the mattress side to support e.g. a mattress. On the side of the top plate averted from the mattress, a spring element arranged on the top plate is provided, which in turn supports itself against a supporting frame.

A support element has become known for instance from the European patent specification EP 0 996 349 B1. The support element described there is formed as an injection moulded part and has a support dish formed integrally with the spring element. The spring element is formed as a leaf spring and comprises supporting arms issuing from a basic body and connected with the support dish, which arms, directed outwardly starting from the basic body, are rotationally symmetrically arranged on the basic body at an angular distance of 120° to 90°. In order to be able to counteract an undesirable spring deflection of individual supporting arms, each of the supporting arms has the same spring constants.

Due to the complicated structure, the manufacture of the support element previously known from EP 0 996 349 B1 is adversely expensive. In addition, as a result of an irregular load distribution on the support dish, it is possible that individual supporting arms are overloaded, which can lead to a detrimental functional failure of the entire support element.

Support elements with helically formed spring elements have become known for instance from DE 67 765 C and DE 104 447 C. The spring elements of the support elements described there are designed as single-stranded elastic springs and consist of spring steel. The disadvantage of these spring elements is that they move out of position and tend to tip sideways uncontrollably when the force is not centrically applied. Moreover, the resilient comfort decreases over time.

Starting from the state of the art described above, the m a in object of the invention is to create a support element avoiding the aforementioned disadvantages, while, being both simple and economical to produce, enabling a reliable application also in long term use. In addition, the main object of the invention is to suggest a spring element, a top plate and a connector.

This task is solved with regard to the support element in that the top plate is made of plastic, the spring element is made of plastic, and the spring element has a multiple-stranded design.

In contrast to the support element known from the prior art, the support element in accordance with the invention has a spring element arranged on a top plate, which spring element is helically formed and tapered with regard to its cross-sectional area, whereby the taper starts from the top plate and extends in the shape of a cone to the end remote from the support surface. The embodiment of the support element in accordance with the invention is characterised by its simple structure. The manufacturing costs can thereby be reduced to a minimum. Moreover, it is particularly beneficial that due to its structure, the spring element also safely withstands uneven application of force to the support element. The support element according to the invention is therefore also particularly suitable as a base for bed mattresses, since even with continuous use of the bed as for instance in the sick and nursing care areas, there is no one-sided functional failure, which can adversely occur with the leaf spring arms known from the prior art. In contrast to the previously known support elements, the support element in accordance with the invention is consequently characterised by its functional safety.

In addition, the support element according to the invention can be cleaned much easier than the support element known from the prior art, which is an advantage in particular when the support element is used in the sick and/or nursing care areas.

According to the invention, it is provided that the spring element have a multiple-, preferably double-, triple-, or quadruple-stranded design. By the multiple-stranded design of the spring element, an improved dimensional stability of the entire support element is achieved. What is more, preferably all strands of the spring element are arranged on the top plate of the support element by means of only one receptacle, such that even with an irregular, i.e. one-sided application of force to the top plate, the force can be introduced into all strands of the spring element. Thus, excessive strain on individual strands of the spring element is reliably counteracted. The formation of several spring element strands, i.e. spring arms, has the additional advantage that the total support force acting upon the support element can be diverted into the structure supporting the support element distributed in accordance with the number of spring element strands used.

The spring element is preferably arranged interchangeably on the top plate. As a result, the top plate and the spring element can be separated from each other, e.g. for cleaning purposes. In addition, the two-piece design of the spring element on the one hand and the top plate on the other hand has the benefit that they can be made of different materials, which is beneficial not only for cost reasons, but also because in this manner, the different functional requirements of the spring element on the one hand and of the top plate on the other hand can be taken into account by an appropriate choice of materials. In this connection, it is particularly beneficial that for instance top plates designed in different sizes can be combined in a modular manner with spring elements which are differently designed with regard to their spring constants, their elastic force, or their pitch of spring. Individual requests for adjustment can therefore be taken into account despite low manufacturing costs.

According to another suggestion of the invention, it is provided that the spring element be arranged in a torsion-proof manner on the top plate. This beneficially prevents an undesirable torsion of the spring element on the one hand and of the top plate on the other hand.

According to the invention, the spring element is made of plastic or metal. In particular for cost reasons, it is beneficial to form the spring element of plastic as an injection moulded part.

According to another feature of the invention, the top plate comprises through-holes, for example in the form of oblong holes. This results not only in a weight reduction due to material savings, but the creation of through-holes also contributes to an improved dimensional stability of the top plate. Moreover, the through-holes serve as air passages for ventilating the rest, for instance a mattress, pad, or the like, supported by the support element on the top plate end. For cost reasons, it is also proposed to form the top plate of plastic as an injection moulded part.

According to another feature of the invention, the support element comprises a connecting element arranged on the spring element located opposite of the top plate for fastening the spring element on a carrier plate. The connecting element therefore serves as a connecting member between the spring element carrying the top plate on the one hand and the carrier plate accommodating the support element, on the other hand.

According to a first proposal of the invention, the spring element and the connecting element can be formed in one piece. Such a design can be beneficial in particular for cost reasons.

According to an alternative proposal of the invention, it is provided that the connecting element be a separate component which is arranged interchangeably on the spring element. The two-piece design of the connecting element on the one hand and the spring element on the other hand has the benefit that corresponding to the respective required material properties, the connecting element and the spring element can be made of different materials. With a two-piece design of connecting element and spring element, the connecting element serves as an intermediate member between the spring element and the carrier plate for the arrangement of the support element on the carrier plate, whereby the connecting element is preferably arranged interchangeably both on the spring element and on the carrier plate. For cleaning purposes, the spring element can thus be separated from the connecting element, and the connecting element can be separated from the carrier plate. In order to prevent an undesirable torsional movement of the support element in relation to the carrier plate, the support element is arranged on the carrier plate in a torsion-proof manner; for this purpose, the connecting element is arranged in a torsion-proof manner both on the spring element and on the carrier plate.

According to another feature of the invention, the connecting element is formed in the shape of a plug and consists of a preferably thermoplastic plastic. The benefit of such a design is that the connecting element can be inserted in a sealing manner into a corresponding receptacle of the carrier plate. In addition, due to the elasticity of the thermoplastic plastic material, the connecting element can be inserted positionally stable into the receptacle formed correspondingly on the carrier plate without any further fastening means, as e.g. screw threads or the like. Therefore, the connecting element can be detached from or arranged on the carrier plate without the use of any tool. Moreover, the connecting element is arranged on the carrier plate with noise insulation in case of possibly occurring vibrations.

Another proposal with the invention is a carrier plate for arranging a support element according to the foregoing description, providing that the carrier plate have a receptacle formed corresponding to the connecting element of the support element. For purposes of torsion protection, it may be provided that with regard to its cross-section, the connecting element does not have a fully circular shape, but a partly circular, elliptical, or polygonal shape instead. The receptacle provided in the carrier plate is formed corresponding to the cross-section of the connecting element.

According to another feature of the invention, the carrier plate has a plurality of receptacles preferably arranged in the form of a row. This makes it possible to arrange a plurality of support elements on the carrier plate. Depending on the size of the carrier plate, a large number of support elements can thus be arranged on the carrier plate, preferably in the form of a row. For cleaning and weight reasons, the carrier plate is preferably formed of plastic.

Furthermore, a bed is proposed with the invention, in particular a sick- and/or nursing bed, comprising a lying area formed by a carrier plate in accordance with the foregoing description. On the mattress side, the carrier plate is equipped with a plurality of support elements according to the type described above, whereby, according to a special feature of the invention, it may be provided that the bed have a plurality of carrier plates which are preferably arranged movable relative to each other. Of course a carrier plate equipped with support elements may be used as lying area or base for other pieces of furniture, such as loungers, massage mats, or the like.

As described above, the support elements according to the invention are arranged interchangeably on the carrier plate forming the lying surface of the bed. This makes it possible to remove the support elements as required, in particular for cleaning purposes. In addition, lying surface areas with zones of support elements having different degrees of resilience can be created in a beneficial manner. Depending on the respective spring elements applied with the used support elements, lying surface areas with varying spring comfort levels can be created. This is particularly beneficial in the sick and nursing area, since in this manner, the individual wishes of the patient lying in the sick- and/or nursing bed can be fulfilled as desired.

As a solution to the aforementioned task with regard to the spring elements, a spring element with at least two spiral and/or helically shaped strip elements consisting of plastic and formed as injection moulded parts is proposed, whereby the strip elements interact in such a way that they give resiliently when force is applied, whereby the spring effect of the strip elements can be predetermined by a suitable choice of geometry and/or material.

With the construction according to the invention, a spring element consisting of plastic is proposed for the first time. The spring element consists of at least two strip elements which have a spiral and/or helical shape.

When force is applied to the spring element, the strip elements give resiliently, thereby causing a spring effect. By a suitable choice of geometry and/or material, the spring effect of the strip elements can be predetermined as required, i.e. in an application-related fashion. This beneficially enables a multi-purpose use of the spring element according to the invention.

Choice of geometry for the purposes of the invention means that the geometry of the strip elements is appropriately adjusted to the application of force to be expected with a use as intended, such that the desired spring effect is achieved. In this sense, transverse and longitudinal extent, cross-sectional form and the like of the strip elements on the one hand and the geometric design of the spring body formed by the spiral or helically formed strip elements on the other hand can be predetermined. So for example with a helical design of the strip elements, it may be provided that the spring body formed thereby be shaped like a cone. It may also be provided that the spring body have an essentially cylindrical shape. The special feature of the invention is that the exemplary geometries specified above can be designed in accordance with the requirements depending on the application, whereby the production is economical, regardless of the chosen geometry, since the spring element is formed as an injection moulded part. The predeterminable geometry of the spring element creates broad possibilities for application, making the spring element beneficially versatile.

Choice of material for the purposes of the invention means that for forming the strip elements, a plastic is used the material properties of which are appropriately adjusted to the application of force occurring during application. Consequently, the used plastic material must be selected such that on the one hand, a sufficient strength of material, and on the other hand, the desired spring stiffness are achieved. In addition, the chosen material should be corrosion-proof and insensitive to maintenance and cleaning agents.

In comparison with conventional spring elements, the spring element according to the invention has the additional advantage that it is designed in a weight-optimised manner, easy to handle, and economical with regard to production and assembly. Moreover, it can be compressed to “zero”, i.e. it can be compressed in height direction up to the stop, thereby providing an extraordinarily long pitch of spring in relation to the longitudinal extent of the spring element in height direction.

According to another feature of the invention, the strip elements are formed in one piece. Therefore, the strip elements may be designed in the form of a component produced by injection moulding. The benefit of producing both strip elements as one component is that there is no need to connect the two strip elements. They can rather be directly used as a spring element after their production. This allows an economical production and easy assembly.

According to another feature of the invention, the strip elements are formed in the same direction in a spiral or helical shape. What is more, the strip elements are preferably staggered against each other corresponding to their spiral and/or helical form, such that forces to be absorbed with a use of the spring element as intended can be absorbed uniformly by the strip elements. What is more, the design of the strip elements allows both bending and torsional strain.

According to another feature of the invention, the strip elements are multi-body elements. Multi-body elements for the purposes of the invention means that the strip elements may be formed of varied body elements which are connected to each other. So for instance, each strip element may be made of one first plastic material which is surrounded by an enveloping second plastic material. In addition, the strip elements made of plastic may have an inset made of metal, for instance. Depending on the application of force to be expected, some sections of the strip elements may also be formed of different body elements. So for instance, it is possible that the strip elements consist of varying body elements in longitudinal direction, whereby the body elements may vary with regard to geometry and material. Thus, it may for instance be provided that the strip elements are tapered in longitudinal direction. The taper may be continuous or in steps. Moreover, the strip elements may be provided with support or reinforcing ribs.

According to another feature of the invention, the strip elements comprise a cross-section deviating from the circular shape. Conceivable are for instance rectangular cross-sections, which are beneficial in particular with regard to bending strain. It is also possible to form cross-sections open on one side, as e.g. U-shaped cross-sections, which are distinguished by high bending stiffness and low torsional stiffness. For weight reasons, also hollow sections may be provided.

According to another feature of the invention, the strip elements have a cross-section changing in longitudinal direction of the strip elements. Accordingly, the strip elements may for instance have a cross-section diminishing in longitudinal direction, such that the strip elements are tapered in longitudinal direction. In addition, cross-sectional shapes may be provided which provide for a taper of the strip elements only in the central area.

According to a special embodiment of the invention, a spring element is proposed having two spiral or helically shaped strip elements designed as spring arms, a base section and a top section located opposite of the base section in height direction of the spring element, whereby all of the base section, the top section, and the spring arms consist of plastic and are formed as injection moulded parts.

A spring element designed in this way is characterised by its compact structural shape. It is preferably designed in one piece and consists of a preferably easy-care plastic. The spring element is formed of two strip elements serving as spring arms which, issuing from a base section, extend in height direction, preferably in helical shape, and are connected to a top section located opposite of the base section in height direction. The top section is preferably formed annularly, whereby the top section side end areas of the spring side are arranged on the inner circumference side of the top section.

The spring element according to the invention can be used beneficially for the most varied purposes. It can for example be used as a bed mattress base. Depending on the size of the bed mattress to be accommodated, a plurality of spring elements is to be used which, preferably arranged in rows side by side, form a common support surface for the bed mattress to be supported resiliently. The spring elements are carried by a supporting structure which is designed for instance in the form of a slatted frame. The supporting structure may also be formed of individual lying surface elements which are arranged movable relative to each other, or otherwise. Decisive is that the spring element according to the invention is independent of the supporting structure used by the user, since the special feature of the spring element according to the invention is the possibility to combine it modularly with supporting structures designed in the most varied manners.

Correspondingly, the spring element according to the invention can also be used as a pad base for seating furniture such as chairs, sofas, or the like. The use of the spring element as a supporting element for the seat and back surfaces of a passenger car and/or lorry seat is also conceivable.

The spring element according to the invention can easily be cleaned, for instance with water, adding cleaning and maintenance agents, if required. It is corrosion-proof and is therefore also suitable for use outdoors, for instance as a seat base for camping and/or garden chairs and/or loungers.

The elastic force resulting from the spring element is determined primarily by the two helically shaped spring arms. Depending on the desired elastic force, the spring arms may be formed as desired with regard to spring arm length, helical twist, material strength, cross-sectional design, and the like. In addition, the spring stiffness of the spring arms can be determined as desired by the choice of the plastic used.

The special feature of the spring element according to the invention is that it can be produced in a simple manner as an integral injection moulded plastic part. Due to its compact structural shape, it is versatile and can be used both as a single component and in combination with components to be connected, as for instance a supporting structure accommodating several spring elements. The spring element according to the invention is weather-resistant, in particular corrosion-proof, and can easily be cleaned with water. In addition, the design of the spring element according to the invention ensures easy handling of the same, in particular with regard to assembly and disassembly.

The spring element according to the invention can be combined with a top plate to be arranged on the top section side, serving as a support surface for the rest to be carried resiliently by the spring element. What is more, several spring elements may be assigned to one common top plate. However, the use of such a top plate is by no means compulsory, but rather optional.

For the purpose of using the spring element according to the invention in combination with a top plate to be arranged on the top section side, the top section of the spring element preferably has recesses on the circumference side. Such recesses serve to arrange the spring element in a torsion-proof manner on a top plate, for which purpose the top plate has holding means formed corresponding to the recesses provided on the top section side of the spring element, which holding elements engage in the recesses of the spring element after an assembly of spring element and top plate. In this manner, a torsion-proof arrangement of the spring element on the one hand and the top plate on the other hand is ensured.

For a positionally stable arrangement of a spring element according to the invention on a top plate to be arranged on the top section side, the top section preferably has through-holes. These through-holes are preferably oblong holes which are formed as part of a bayonet catch and have sections of varying transverse extent. For the purpose of assembling the spring element and the top plate, retaining elements formed correspondingly on the top plate can be inserted into the through-holes of the spring element and locked in the through-holes of the spring element provided for this purpose by a relative turn in relation to the spring element. In combination with the retaining elements formed on the top plate, the through-holes in the spring element form a bayonet catch which can easily be opened and closed. Therefore, the spring element and the top plate can easily be connected with each other. Thanks to the bayonet catch, the connection between the spring element and the top plate can easily be released if required, which is beneficial insofar as the spring element can easily be detached from the top plate for cleaning purposes. The bayonet catch in combination with the recesses formed on the circumference side of the top section creates a torsion-proof and force-transmitting connection between the spring element and the top plate.

The top section of the spring element preferably has stiffening ribs on its bottom side facing the base section. These stiffening ribs serve to additionally stabilise the top section of the spring element. The design of a stiffening rib in the form of an annular enlargement which is preferably arranged on the bottom side of the top section has proved to be particularly advantageous. In addition, the through-holes of the top section may be provided with a stiffening rib surrounding them. According to a special feature of the invention, the latch means which are preferably provided on the bottom side of the top section with regard to the design of the bayonet catch, may be an integral part of one or more of the stiffening ribs formed on the bottom side of the top section. This embodiment enables a particularly economical fabrication.

In accordance with another feature of the invention, the base section of the spring element can be connected with at least one means for the arrangement on a counterpart. Possible counterparts are support structures of the most varied designs on which the spring element can be arranged. Counterparts in this sense can be lying surface elements, grid frame structures, slatted frames, or the like. The means for arrangement on a counterpart is formed by a preferably pin-shaped extension. For the purpose of arranging the spring element on a supporting structure, the latter has an opening formed corresponding to the pin-shaped extension, into which the pin-shaped extension can easily be inserted to arrange the spring element on the supporting structure. The pin-shaped extension may be enveloped by a slightly elastic material, such that the pin-shaped extension may be pressed positionally stable into the opening formed on the supporting structure with deformation of the elastic material. The elastic material also serves as a noise dampening component.

Due to the possibility to arrange the spring element interchangeably on a supporting structure, it is individually usable for the most varied applications. This is not possible with conventional spring elements known from the prior art. The same applies to the optional possibility to arrange a top plate on the top section side of the spring element. In this manner, the most varied applications can be considered as required, which has not been possible with the spring elements known from the prior art.

In accordance with another feature of the invention, the end areas of the spring arms on the top section side are arranged on the top section, whereby they are preferably aligned opposite each other. Starting from the base section, the spring arms have a helical twist of more than 180°, preferably of more than 270°. In accordance with a preferred embodiment, the helical twist of the spring arms starting from the base section is 360°.

The base section of the spring element is preferably S-shaped and connects the two end areas of the spring arms provided on the base section side.

The outer diameter of the annularly formed top section may be designed as required, depending on the application. The outer diameter preferably has a size of 5 to 14 cm, preferably of 9 to 13 cm, preferably of 10 to 12 cm. In accordance with a special embodiment of the invention, the outer diameter has a size of 11 cm.

According to another feature of the invention, the spring element has a longitudinal extent of 3 cm to 7 cm in height direction, preferably of 4 cm to 6 cm. According to a special embodiment of the invention, the longitudinal extent of the spring element in height direction is 5 cm.

With regard to the sizing dimensions of the spring element, it is understood that these may be designed as desired considering the application, i.e. depending on the desired elastic force. Of course it is also possible to combine spring elements of different sizes. So for instance, when several spring elements are used as a base for a bed mattress, those spring elements bearing the heaviest load with a use of the bed as intended may be larger with regard to their geometric dimensions than those spring elements bearing a comparably smaller load. For instance, the spring elements in the head area of the mattress may be designed smaller than the spring elements provided for support of the mattress in the central area.

Altogether, a compact structural member which is easy to handle with regard to assembly and disassembly is made available which can be combined in an easy manner with other components, as for instance a supporting structure and/or top plate for the purpose of the intended use. The use of the spring element according to the invention is therefore unlimited, and it may be formed as required with regard to sizing dimensions, resilient comfort and spring stiffness, depending on the desired spring comfort level. Solely essential for the invention is that the spring element consisting of spring arms, base section, and top section is formed of plastic and in one piece.

Furthermore, a spring module is proposed with the invention, formed of spring elements of the type described above which are connected to each other on the top section side or on the base section side. Therefore, the spring module consists of two separately formed spring elements combined to form a common spring module. The two spring elements may be connected either via their base sections or via their top sections. For the purpose of forming such a spring module, the spring elements need not be restructured, but they can rather be easily connected by corresponding connecting elements.

Another proposal of the invention is a spring module, formed by a spring element of the type described above, and a top plate arranged on the top section side of the spring element. What is more, several spring elements may be arranged on one and the same top plate. The top plate is preferably made of plastic and is injection moulded. The top plate may be formed in accordance with its intended use and have for instance a circularly, elliptically, rectangularly or similarly formed support surface. In addition, the top plate may have through-holes, stiffening ribs, or the like.

The connection between the top plate on the one hand and the spring element on the other hand is preferably formed such that it can be easily produced and released as required. Such a releasable arrangement of top plate and spring element is beneficial in particular for hygienic reasons, since the top plate and the spring element can be separated from each other for cleaning purposes. For a positionally stable arrangement of the top plate, the spring element is arranged thereon in a torsion-proof manner.

According to another feature of the invention, the spring module has a connection means on the base section side of the spring element, which serves to arrange the spring element on a supporting structure. The connection means is preferably formed as a plug-in connection, such that the base section side of the spring element can easily be arranged on a correspondingly formed supporting structure.

As far as the top plate is concerned, for the solution of the aforementioned task, a receiving element for an at least area-wise accommodation of a mattress, pad, or the like is proposed with the invention, whereby several receiving elements arranged side by side form a common support surface, characterised in that it is plate-shaped in dish style and has means for a detachable arrangement on a carrier element.

According to the invention, the receiving element serving as support dish or top plate is formed as a separate component. It has means for the detachable arrangement on a carrier element, for instance a spring element, such that it can be combined as desired with a carrier element for use as intended. This type of design has several advantages. On the one hand, the receiving element may be combined as desired in a modular assembly concept with differently formed carrier elements. In relation to the respective application, it is therefore possible to combine a carrier element of any design with the receiving element according to the invention. For instance, it may be provided that the carrier element is formed as a spring-elastic element. The carrier element may also be a purely supporting element without any spring-elastic properties. The possibility to combine the support element in a modular assembly concept with carrier elements of different functional designs is advantageous in particular from an economic point of view, because despite the different functions of suitable carrier elements, it is not required to use different receiving elements, but rather one and the same receiving element can be combined with differently designed carrier elements. Another advantage is that the receiving element can be arranged detachably on the carrier element, since this permits the user to separate the receiving element from the carrier element, for instance for cleaning purposes. The carrier element and the receiving element can therefore be cleaned separately. The detachable arrangement is also beneficial in case of a possibly necessary repair. That is to say, a possibly defective receiving element can be removed from the respective associated carrier element and replaced by a new receiving element without having to exchange the carrier element. Of course the same applies to the replacement of a carrier element, since the receiving element arranged thereon can also be used in combination with a newly inserted carrier element. Therefore, the embodiment according to the invention not only proves to be easily handled, but it also permits a reduction of costs, in particular in case of repair, since on the one hand, it is possible to replace the receiving element without having to replace the carrier element at the same time, and on the other hand, it is possible to exchange one carrier element for another without requiring the insertion of a new receiving element, because the latter can be combined with either one of the carrier elements. What is more, the interchangeable arrangement of the receiving element on the one hand and of the carrier element on the other hand is advantageous not only in case of repair, but the receiving element according to the invention is suitable to be combined with carrier elements of different designs; therefore, depending on the application, carrier elements designed with different functions can be combined with one and the same receiving element, which is particularly beneficial when the receiving element according to the invention is used in the field of sick- and/or nursing beds. So it may for instance be provided that the inserted carrier elements are adjusted to the needs of the patient lying in the bed, and when the sick- or nursing bed is put to use again, the carrier elements are readjusted to the needs of the person lying in the bed. For this purpose, specially designed carrier elements may be inserted at least area-wise, while the same receiving elements are used.

According to another feature of the invention, the receiving element is formed in one piece, which contributes to simple production and easy handling. The receiving element preferably consists of plastic and is injection moulded, which has the advantage that it is corrosion-proof with regard to external influences, as for instance water or urine. Moreover, a receiving element consisting of plastic can easily be cleaned, for instance by using water. In addition, a receiving element made of plastic has a comparatively low weight, which also contributes to facilitated handling.

According to an alternative embodiment, the receiving element can have an inset made of metal which, for stability reasons, can be advantageous in particular when the receiving element has to bear heavier weights, for instance when the superimposed load to be borne by the receiving elements is particularly heavy. An example for the application of such heavy loads are beds, in particular sickbeds and/or nursing beds for heavy-weight persons.

According to another feature of the invention, it is provided that the receiving element is arranged in a torsion-proof and/or displacement-proof manner on the carrier element, for which purpose the receiving element has correspondingly formed latch means. As latch means for this purpose, e.g. snap-locks may be provided which, in assembled condition, engage in correspondingly formed cavities on the carrier element. Also pin-shaped extensions engaging in correspondingly formed borings on the carrier element in assembled condition of receiving element and carrier element may be used as latch means. Of course other fastening methods can serve as latch means as well, as e.g. screws or the like.

According to another feature of the invention, the receiving element has through-holes. The object and purpose of such through-holes is to accommodate in a breathable manner the mattress, pad or the like accommodated by the receiving element, i.e. to make sure that the mattress, the pad or the like is in contact with the atmosphere surrounding the mattress, the pad or the like also on the bottom side via the through-holes formed in the receiving element.

According to another feature of the invention, the receiving element has a circular section on the one hand and a surface section arranged thereon on the other hand. In addition, several surface sections arranged on the circular section may be provided, whereby in the preferred case of two surface sections, these are arranged opposite each other on the circular section. Both the circular section and the surface section arranged thereon, or the surface sections arranged thereon, respectively, serve to accommodate in a supporting manner the mattress, pad, or the like to be accommodated by the receiving element. For the purpose of a detachable arrangement of the receiving element on the carrier element, the circular section has a receiving area on the side averted from the mattress, the pad, or the like which serves to accommodate the section of the carrier element formed corresponding to the receiving area of the receiving element. A torsion-proof and/or displacement-proof arrangement of the receiving element in relation to the carrier element can additionally be supported in that the circular section has a circumferential collar projecting from the surface plane of the circular section on the side averted from the mattress, the pad, or the like.

The construction of the receiving element described above has proved to be particularly robust and to withstand even larger strain. In order to further increase the stability of the receiving element, it may be provided according to another feature of the invention that the receiving element has reinforcing ribs connecting the circular section with the surface section or the surface sections, respectively. These reinforcing ribs beneficially cause a stiffening of the entire receiving element, which is advantageous in particular with regard to the bending strains occurring also with the use of the receiving element as intended.

According to another feature of the invention, a central sector is arranged within the circular section, which central sector the reinforcing ribs lead into. This structural design as well results in an additional strengthening of the receiving element, in particular because the forces acting on the receiving element during use as intended can be distributed evenly across the entire receiving element. Not least for this reason, the receiving element is preferably designed mirror- and/or rotationally symmetrical.

According to another feature of the invention, the surface section or the surface sections has/have ribs on its/their side(s) facing the mattress, the pad, or the like. These ribs serve to stiffen the surface section or surface sections on the one hand, and they help to prevent an undesirable relative displacement between the receiving element and the mattress, pad, or the like deposited on top of it, on the other hand. To that extent, the ribs arranged on the surface section or surface sections, respectively, act as anti-slide means.

According to another feature of the invention, the carrier element is a spring-elastic element. In addition, other embodiments with regard to the carrier element may be provided; however, decisive is the fact that the carrier element can be connected releasably with the receiving element to be arranged on it. For this purpose, according to another feature of the invention, the carrier element has a section on the receiving element side formed corresponding to the receiving area of the receiving element. In assembled condition of receiving element and carrier element, this section protrudes into the receiving area formed on the receiving element. At the same time, the collar arranged on the bottom side and surrounding the receiving area ensures that no undesirable displacement of the receiving element in relation to the carrier element occurs. For the purpose of a torsion-proof arrangement of the receiving element on the carrier element, correspondingly formed means may be provided on the receiving element, for instance in the form of a cam-and-groove arrangement. Of course the carrier element and the receiving element may also be connected to each other by screws.

According to another feature of the invention, it is provided that the end area of the carrier element located opposite of the receiving element comprises means for arranging the carrier element on a supporting structure. The lying surface of a bed, in particular of a sick- and/or nursing bed, may be provided as supporting structure. This lying surface can be designed such that it accommodates a plurality of carrier elements preferably to be arranged side by side, each of which in turn carries an associated receiving element. Several receiving elements arranged side by side then form a common support surface in order to accommodate a mattress, a pad, or the like. According to an alternative embodiment of the invention, it may also be provided that the receiving element is supported by more than only one carrier element, for instance by two, three, or four.

In assembled condition, the receiving element according to the invention and the carrier element detachably arranged thereon form an easy-to-handle unit which can be designated as a support element. The support element consisting of receiving element and carrier element can be supplied to the user pre-assembled by the manufacturer. Of course it is also possible to deliver the receiving element and the carrier element separate from each other to the user, who then has to arrange the receiving element on the carrier element, as intended. The interchangeable arrangement of receiving element and carrier element is not only beneficial in that they can be separated from each other for instance for cleaning purposes, but the two-piece embodiment is also advantageous in that the receiving element and the carrier element can be made of different materials, which is not only an advantage for cost reasons, but also because in this manner, the different functional requirements of receiving element on the one hand and carrier element on the other hand can be taken into account by an appropriate choice of material. A particular advantage in this connection is that for instance receiving elements differently designed with regard to their size can be combined with differently designed carrier elements, so e.g. when the carrier element is designed as a spring element, it can be combined with carrier elements that are differently designed with regard to their spring constant, their elastic force, or their pitch of spring. Individual requests for adjustment can therefore be taken into account despite low manufacturing costs.

The receiving element which can be arranged interchangeably as a top plate on the carrier element preferably has through-holes, resulting not only in a weight reduction due to material savings, but the formation of through-holes also contributes to an improved dimensional stability of the receiving element. Moreover, the through-holes serve as air passages for ventilating the rest, which can be for instance a mattress, a pad, or the like accommodated by the receiving element when used as intended.

In order to arrange the carrier element on a supporting structure, it is proposed that the carrier element have a connecting element on the side located opposite of the receiving element when assembled. The connecting element serves as a connecting member between the carrier element carrying the receiving element on the one hand, and the supporting structure accommodating the carrier element, on the other hand.

According to a first proposal, the carrier element and the connecting element can be formed integrally. Such a design can be beneficial in particular for cost reasons.

According to an alternative proposal, it may be provided that the connecting element be a separate component which can be arranged interchangeably on the carrier element. The two-piece design of the connecting element on the one hand and the carrier element on the other hand has the benefit that corresponding to the respective required material properties, the connecting element and the carrier element can be made of different materials. With a two-piece design of connecting element and carrier element, the connecting element serves as an intermediate member between the carrier element and the supporting structure for the arrangement of the carrier element on the supporting structure, whereby the connecting element is preferably arranged interchangeably both on the carrier element and on the supporting structure. For cleaning purposes, the carrier element can thus be separated from the connecting element, and the connecting element can be separated from the supporting structure. In order to prevent an undesirable torsional movement of the carrier element relative to the supporting structure, the carrier element is arranged on the supporting structure in a torsion-proof manner; for this purpose, the connecting element can be arranged in a torsion-proof manner both on the carrier element and on the supporting structure.

The connecting element is preferably designed in the form of a plug. It consists of plastic, preferably a thermoplastic plastic. The benefit of such a design is that the connecting element can be inserted in a sealing manner into a corresponding receptacle of the supporting structure. In addition, due to the elasticity of the thermoplastic plastic material, the connecting element can be inserted positionally stable into the receptacle formed correspondingly on the supporting structure without any further fastening means, as e.g. screw threads or the like. Therefore, the connecting element can be detached from or arranged on the supporting structure without the use of any tool. Moreover, the connecting element is arranged on the supporting structure also with noise insulation in case of possibly occurring vibrations.

In addition, a bed is proposed with the invention, in particular a sick- and/or nursing bed, comprising a lying surface formed as a supporting structure in the sense described above, which lying surface is provided with carrier elements of the type mentioned above, and which carrier elements are provided with receiving elements of the type according to the invention.

With regard to the connector, for the solution of the aforementioned problem, a connector is further proposed with the invention for the arrangement of a functional element on a basis, with a plug-shaped section which can be inserted into a recess formed on the basis, for which purpose the plug-shaped section is formed corresponding to the recess of the basis, whereby the plug-shaped section itself comprises a recess to accommodate a connecting element arranged on the functional element.

Functional elements for the purposes of the invention are elements which are applied in accordance with the object and purpose of their technical function, whereby for use as intended, the elements are typically arranged on a basis, i.e. on a supporting structure. Functional elements in this sense can for instance be spring elements of the type used as a spring-elastic base for sitting and lying surfaces of furniture.

In order to arrange such functional elements on a basis, fastening means, as e.g. screws, rivets, or the like can be used. Such fastening means are well known from the prior art, however, they have the disadvantage that assembly and disassembly of the functional elements is comparably complex. In addition, the functional elements cannot easily be detached from the basis, for instance when rivets are used. In order to avoid this disadvantage, the use of threaded fastening means, as e.g. screws or threaded pins, has been known. However, the use of such fastening means requires the formation of corresponding mating screw threads, which is more complex not only for cost reasons on the one hand, but which requires a comparably time-consuming assembly on the other hand, which must be accomplished either by the manufacturer or by the user.

The connector according to the invention is formed as a plug-in part and can be designated as a coupling element or connecting element which connects the functional element with the basis when used as intended. The connector comprises a plug-shaped section which, for the purpose of arranging a functional element on a basis, can be plugged into a recess formed on the basis. For a positionally stable arrangement, the plug-shaped section is formed corresponding to the recess in the basis. Therefore, it may for instance be provided that the plug-shaped section has an essentially circular cross-section. Correspondingly, the recess formed on the basis also has an essentially circular cross-section and is formed for instance as a boring. The plug-shaped section of the connector is plugged into this boring for the purpose of arranging a functional element. In order to ensure a torsion-proof arrangement of the plug-shaped section, both the recess formed on the basis and the plug-shaped section can have a cross-section deviating from the circular form and can for instance be shaped angularly.

The plug-shaped section in turn has a recess which serves to accommodate a connecting element arranged on the functional element. In its simplest embodiment, the plug-shaped section has an essentially circular recess into which the connecting element of the functional element, which is for instance formed as a pin-shaped extension, can be plugged. In order to ensure a torsion-proof arrangement of the functional element in relation to the connector, the cross-sections of the connecting element on the one hand and of the recess formed in the plug-shaped section on the other hand can have a design deviating from the circular form and be shaped for instance elliptically or angularly.

The arrangement of a functional element on a basis can be accomplished in the easiest possible way using the connector according to the invention. In a first step, the connector must be plugged into a recess formed on the basis. Then, in a second step, the connecting element of the functional element must be inserted into the recess of the plug-shaped section of the connector. As a result, the functional element is arranged on the basis as intended. The connection between the functional element and the basis formed in this manner can easily be released, if required, since all that is required is to pull the functional element out of the connector and the connector out of the recess formed in the basis. Such a disassembly occurs in a non-destructive manner, such that both the connector and the functional element can be put to further use. As far as assembly is concerned, it is understood that according to an alternative procedure, initially the connector can be arranged on the functional element, such that in a second assembly step, the connector together with the functional element already arranged thereon is plugged into the recess formed on the basis.

The connector in accordance with the invention allows easy handling, because no complex assembly or disassembly works are required, since the basis and the connector on the one hand and the connector and the functional element on the other hand are simply plugged together. With a corresponding design, the connection formed by the connector between the functional element and the basis is torsion-proof, allows a secure arrangement of the functional element on the basis, and can be released non-destructively if required.

According to a special feature of the invention, the plug-shaped section of the connector is made of an elastic material, for example plastic. A suitable plastic is in particular an injection-moldable plastic material, enabling a particularly simple fabrication of the connector. In order to promote a secure arrangement of the functional element on the basis, the plug-shaped section of the connector can be slightly overdimensioned in relation to the recess formed on the basis. Due to such an overdimension, the connector must be pushed or pressed into the recess formed on the basis for the purpose of assembly, whereby the overdimension should be such that pushing-in or pressing-in can be achieved by simple pressure of the finger without the aid of any tools. A special advantage of this embodiment is the fact that, as a result of the connector being pushed or pressed into the recess formed on the basis, the connector is fixed positionally stable in relation to the basis.

Another advantage of the connector over conventional fastening means is that it has a noise-dampening effect. This is because the functional element and the basis are not directly in contact with each other. Possibly noise-inducing vibrations of either the basis or the functional element can be absorbed via the connector arranged between the functional element and the basis, in particular when the connector is made of plastic. Possibly disturbing contact noises between the functional element and the basis can therefore be avoided.

Another advantage is that the connector forms a liquid-tight connection between the functional element on the one hand and the basis on the other hand. This property of the connector is particularly beneficial when the functional element and the basis are intended to be used in a liquid-sensitive area. As an example, the design of the functional element as a spring element may be mentioned which, for the purpose of supporting the lying surface of a bed, for example a mattress, is arranged on a basis designed as a supporting structure for the mattress.

In order to support the tightening function of the connector as described in the invention, according to another feature of the invention, the connector may comprise a collar which is arranged on the plug-shaped section of the connector and, in assembled condition, rests against the upper side of the basis. According to a special advantage of the invention, this collar comprises a sealing lip, so as to ensure that the collar rests against the basis in a liquid-tight manner. In addition, it may be provided that the collar comprises sealing lamellas on its bottom side facing the basis which also contribute to the liquid-tight fitting of the connector to the basis.

According to another feature of the invention, the plug-shaped section comprises a latch means on one end which, in assembled condition of the connector, rests against the bottom side of the basis. The latch means can be designed as a circumferential bulge one end of which is arranged on the plug-shaped section, whereby the plug-shaped section and the circumferential bulge are formed in one piece. After assembly, the circumferential bulge designed as a latch means engages behind the bottom side surface of the basis, thereby preventing an unintentional release of the connector from the recess formed in the basis. For the purpose of disassembly, the end of the plug-shaped section carrying the latch means must be compressed such that it can be removed from the recess formed in the basis. The thickness of the circumferential bulge and the material properties of the connector are matched to each other such that the plug-shaped section can be compressed by hand, i.e. without the use of any tools.

In its most simple embodiment, the connector according to the invention consists solely of a plug-shaped section. This plug-shaped section consists of an elastic material, preferably plastic, and is inserted into a correspondingly formed recess on the basis for the purpose of arranging the functional element on the basis. According to another embodiment, the plug-shaped section may comprise a latch means on one end which, in assembled condition of the connector, rests against the bottom side of the basis and prevents the connector from being undesirably pulled out of the recess formed in the basis.

Furthermore, it may be provided that the plug-shaped section has a collar on the other end which, in assembled condition of the connector, rests against the upper side of the basis. This collar can comprise both a sealing lip and sealing lamellas. The plug-shaped section, the collar, and the latch means ate preferably formed in one piece and consist of an elastic material, as described above.

According to another feature of the invention, the plug-shaped section comprises reinforcing ribs on its outer circumference side extending radially outward. These reinforcing ribs are advantageous for three reasons. First of all, they reinforce the plug-shaped section both with regard to its bending stiffness and with regard to its torsional stiffness. Furthermore, they serve to arrange the plug-shaped section in a torsion-proof manner in the recess formed on the basis, which recess, with regard to its cross-section, is formed corresponding to the plug-shaped section carrying the reinforcing ribs. Moreover, the recess formed in the plug-shaped section for accommodating the connecting element of the functional element and the reinforcing ribs can be matched to each other such that when the connecting element is inserted into the recess of the plug-shaped section, the reinforcing ribs are pressed apart, thereby causing a particularly secure hold of the connector in the recess of the basis.

According to another feature of the invention, it is provided that on one end, the plug-shaped section comprises a groove formed on the inner circumference side which, in assembled condition of the connector, is engaged by an undercut formed on the connecting element of the functional element. By this design, a positionally stable arrangement of the functional element in relation to the connector is achieved, thereby preventing an unintended release of connector and functional element. The latch means arranged on the plug-shaped section of the connector therefore ensures that the connector cannot be unintentionally detached from the basis, while the combined effect of the groove on the connector side and the undercut on the functional element side ensures that the functional element cannot be unintentionally detached from the connector. As a result, this construction creates an arrangement between the basis and the functional element which, when used as intended, ensures that the functional element is arranged on the basis in a positionally accurate and secure manner, while the functional element and the basis cannot be unintentionally separated from each other. At the same time, it may be provided supplementary to the construction described above that the plug-shaped section of the connector be shaped conically both inside and outside.

The connector according to the invention can be formed as an injection moulded part, thereby rendering its production simple and economical. It is easy to use in a beneficial manner and allows the formation of a reliable connection between the functional element on the one hand and the basis on the other hand. It can easily be assembled and disassembled, and since a disassembly is non-destructive, the connector can be used several times. Assembly and disassembly of the connector can occur without the use of any tools, therefore it can be accomplished quickly and in a simple manner. Another advantage is that the connector according to the invention is noise-absorbing, i.e. it has a noise-dampening effect. Moreover, it seals the connecting point between the functional element and the basis, which is of particular advantage when the connector is used in liquid-sensitive areas. Therefore, the connector according to the invention can be applied universally, enabling an application specific to the individual user.

Furthermore, the invention relates to a device for the accommodation of pads for padding sitting or lying furniture, with a plurality of support elements arranged adjacent to each other, whereby each support element comprises a spring element and a pad receptacle arranged thereon, whereby the spring element has a multiple-stranded design and comprises at least two spiral and/or helically shaped spring arms and whereby the spring element consists of plastic.

The device according to the invention has a plurality of support elements which are arranged adjacent to each other and are carried for instance by a carrier stand, a carrier plate, an arrangement of slats, or the like. The support elements in turn support a pad arranged thereon in a spring elastic manner. This results in a particularly good sitting and/or lying comfort. What is more, the support elements can be used for all pads of a piece of sitting and/or lying furniture.

Each of the support elements of the device according to the invention comprises a spring element on the one hand and a pad receptacle arranged thereon, on the other hand. The spring element in turn has a multiple-stranded design and has at least two spiral- and/or helically shaped spring arms. The entire spring element is formed as an injection-moulded part and consists of plastic, whereby the spring arms of the spring element interact such that they give resiliently when force is applied, whereby the spring effect of the spring arms can be predetermined by a suitable choice of geometry and/or material.

This enables in a beneficial manner a versatile use of the support elements which can be combined with each other as desired by size, number, resilient comfort, and the like to form the device according to the invention.

In comparison with conventional spring elements made of spring steel, the spring elements consisting of plastic according to the invention have the advantage that they are formed weight-optimised, they are easy to handle, and economical with regard to production and assembly. Moreover, in particular with a helical design, the spring element can be compressed to “zero”, i.e. it can be compressed up to the stop in height direction, thereby providing an extraordinarily long pitch of the spring in relation to the longitudinal extent of the spring element.

According to the invention, the spring element has a multiple-stranded design, i.e. it has at least two spring arms. The advantage of this design can be seen in particular in that the forces to be absorbed when the device according to the invention is used as intended can be absorbed evenly by the spring arms. What is more, the formation of the spring arms allows both bending and torsional strain. The design with more than two spring arms, i.e. for instance the design with three, four or more spring arms is within the scope of the invention.

According to the invention, each support element of the device according to the invention has a pad receptacle, for instance in the form of a receiving element serving as a top plate. This pad receptacle is arranged on the spring element of the respective support element. Just as the spring element, the pad receptacle as well consists of plastic and is preferably formed as an injection moulded part.

The pad receptacle can for instance be formed plate-shaped in the style of a top plate and comprise through-holes in the form of borings or oblong holes, if required. According to another feature of the invention, the pad receptacle formed in the style of a top plate can be formed annularly, whereby both circular and polygonally formed ring designs are imaginable. Preference is given to the polygonal design of the annular pad receptacle, in particular to the pentagonal and/or hexagonal design.

Essentially, the device according to the invention has two advantages. On the one hand, a noticeably improved sitting and/or lying comfort is achieved by the spring-elastic properties of the spring elements. On the other hand, a rear ventilation of the pads placed on top of the device according to the invention is possible. This, too, improves the sitting and/or lying comfort, since “sticking” to the pad material due to sweat formation is beneficially prevented. Moreover, the device according to the invention proves to be extremely easy to care for, since the individual support elements consisting of plastic, i.e. the spring elements and the pad receptacles, can easily be cleaned using conventional cleaning and maintenance agents. The device according to the invention can therefore be used not only for indoor, but also for outdoor furniture, as for instance garden or camping furniture or the like.

According to the invention, it is provided that the device for the accommodation of pads for padding sitting and lying furniture comprise a plurality of adjacently arranged support elements. The number of the support elements to be inserted is determined by the size of the seat, back, arm, or leg area to be formed as desired. The support elements can be arranged in the form of rows or staggered against each other in longitudinal and/or transverse rows. There are no limits to imagination, since according to the invention, it is solely important that a plurality of adjacently arranged support elements forms a device according to the invention to accommodate pads. For purposes of better handling, the individual support elements of the device can be coupled to each other, resulting in a mat-like design.

In a preferred embodiment of the invention, the pad receptacles of the support elements are formed annularly and have a polygonal, preferably hexagonal outer contour. The advantage of this embodiment is that the adjacently arranged support elements of the device according to the invention are staggered against each other in longitudinal and/or transverse direction, which serves to distribute the introduced force to several support elements on the one hand and helps to avoid unnecessary gaps or clearances between individual support elements, on the other hand.

According to a first alternative of the invention, each support element of the device according to the invention is formed in one piece, i.e. the spring element and the pad receptacle of the support element form an integral support body. Alternatively to this embodiment, it may be provided that both the spring element and the pad receptacle of a support element are designed as one-piece structural members. These are combined with each other as desired for the final use of a support element, whereby the pad receptacle is arranged preferably interchangeably on the spring element. This type of design offers the advantage that the pad receptacle and the spring element may be made of different plastics. For a positionally stable fixation of the pad receptacle on the associated spring element, both the spring element and the pad receptacle have connection means formed corresponding to each other. In this connection, for instance a pin arranged on the spring element side of the pad receptacle and engaging in a corresponding boring formed on the spring element may be provided as connecting element. In order to be able to prevent an unintentional separation of the spring element on the one hand and the pad receptacle on the other hand, latch means securing the connection between the spring element and the pad receptacle are provided.

According to another feature of the invention, it is provided that the spring arms of the spring element, starting from a base section, have a helical twist of more than 180°, preferably of more than 270°. As already described above, the helical design of the spring arms has the advantage that the spring element can be compressed to “zero”. Depending on the desired pitch of the spring, the spring arms must be of an appropriate length such that depending on the selected ascent, several helical twists can be provided. Preference is given to the formation of only one helical twist, in which case the spring arm, starting from the base section, has a helical twist of 360°.

According to another feature of the invention, the base section of each spring element on the bottom side of the spring element averted from the spring arms comprises a means to arrange the spring element on a counterpart. Such a counterpart can be for instance a supporting frame, a carrier plate, a carrier frame, an arrangement of slats, or the like. The means for arrangement on a counterpart is preferably a pin-shaped extension which can be inserted in a torsion-proof manner into a boring on the counterpart. For the purpose of a torsion-proof arrangement, it can be provided that the extension has a cross-section deviating from the circular form.

According to another feature of the invention, the preferably annularly formed pad receptacle can have an outer diameter of D_{A}=2 cm to 8 cm. Preference is given to the design of an outer diameter of D_{A}=3 cm to 7 cm, and even more preference to D_{A}=4 cm to 6 cm. Depending on the desired maximum pitch of the spring in height direction, the spring element can have a longitudinal extent in height direction of L_{H}=1 cm to 5 cm, preferably L_{H}=2 cm to 4 cm. However, these numerical values mentioned as examples are not restrictive for the invention, since according to the invention, the only important thing is that a plurality of support elements which can be combined as desired form the device according to the invention.

Other features and advantages of the invention result from the description on the basis of the figures. Shown are in:

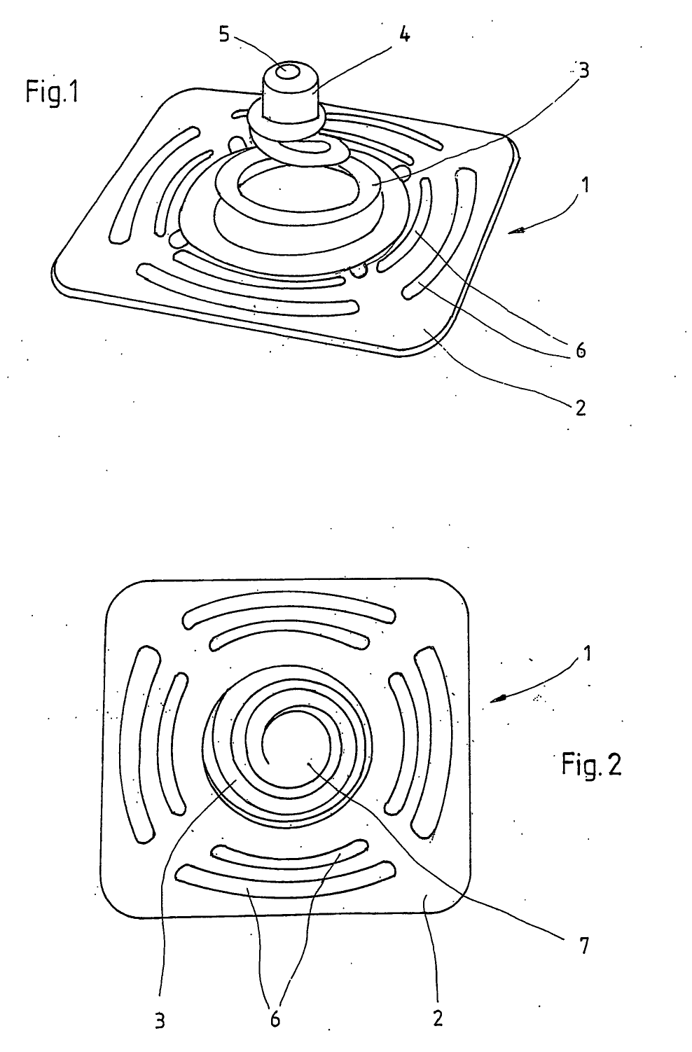

FIG. 1 in a three-dimensional view, the support element according to the invention;

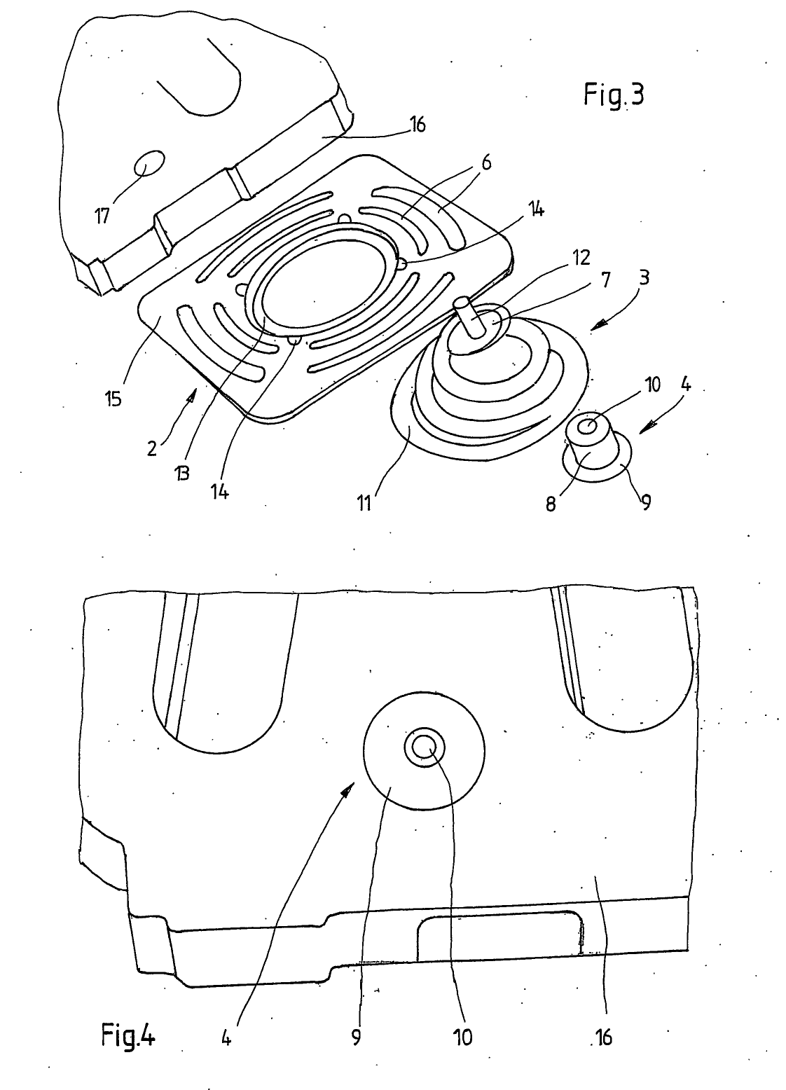

FIG. 2 in plan from above, the support element according to the invention;

FIG. 3 the individual components of the support element according to the invention;

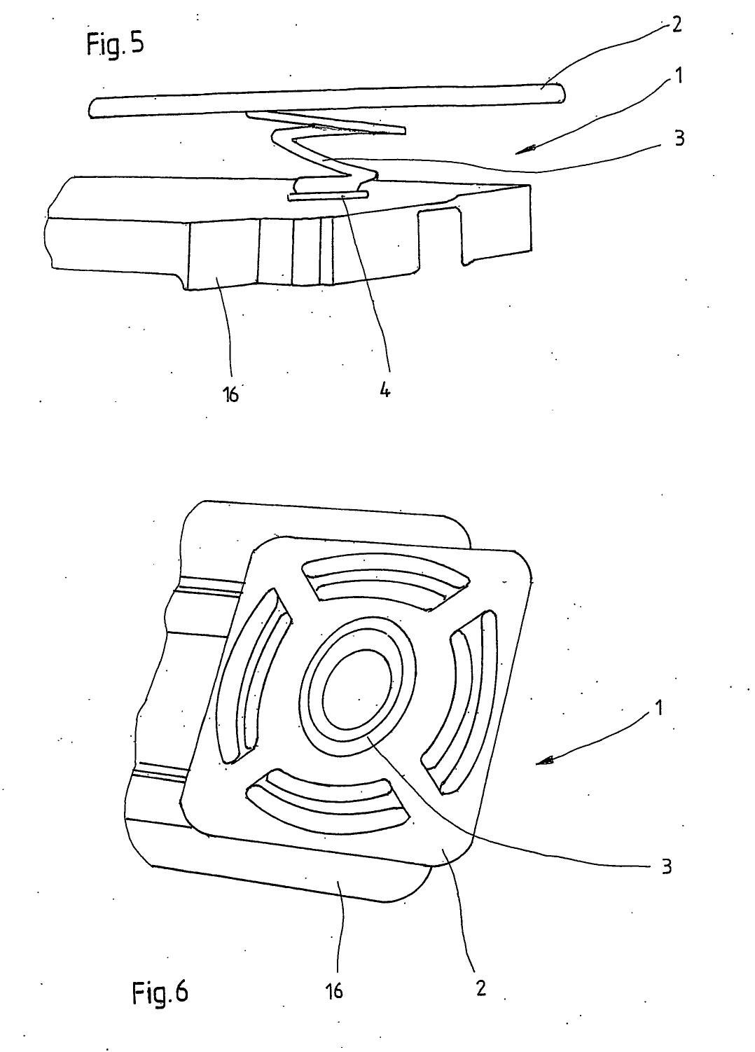

FIG. 4 a connecting element arranged on a carrier plate;

FIG. 5 in a side view, a support element according to the invention arranged on a carrier plate;

FIG. 6 in a perspective view, a support element according to the invention arranged on a carrier plate;

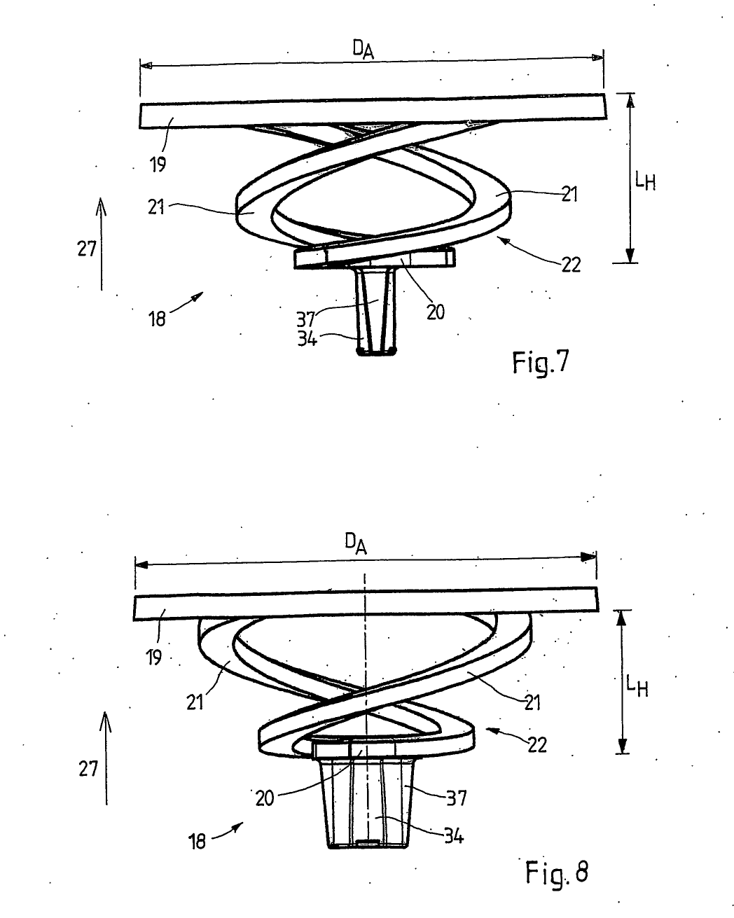

FIG. 7 the spring element according to the invention in a first side view;

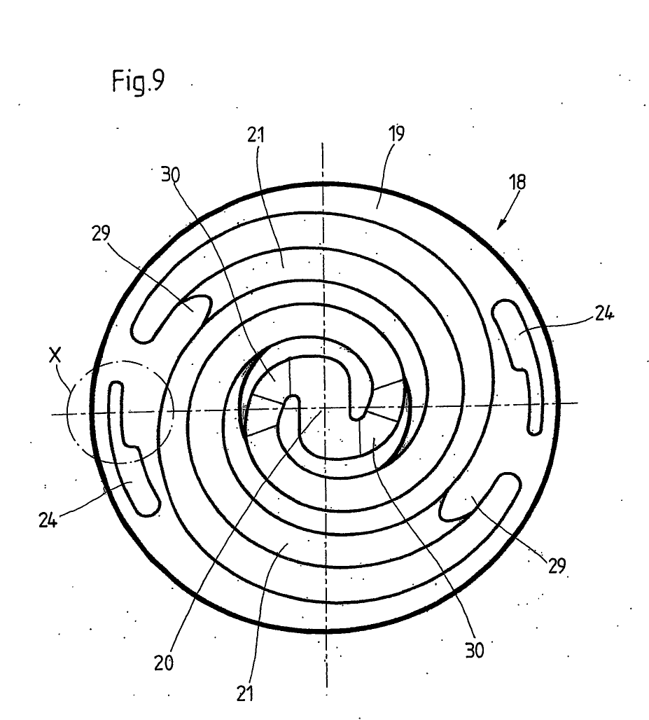

FIG. 8 the spring element according to the invention in a second side view;

FIG. 9 the spring element according to the invention in plan from above;

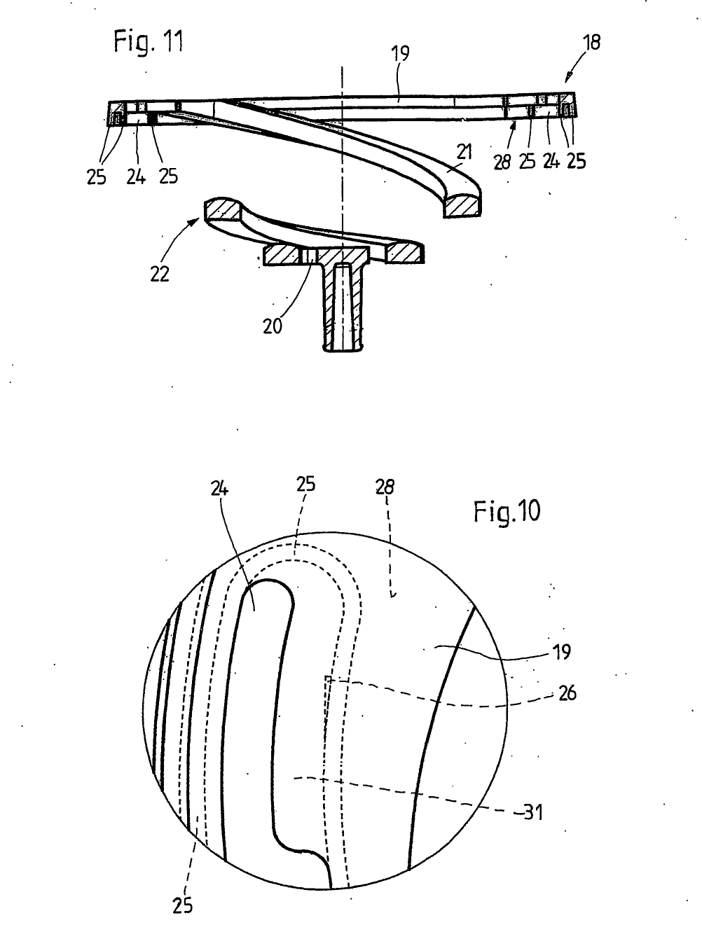

FIG. 10 a partial section of the spring element according to the invention pursuant to the sectional line in FIG. 9;

FIG. 11 the spring element according to the invention in a sectioned side view;

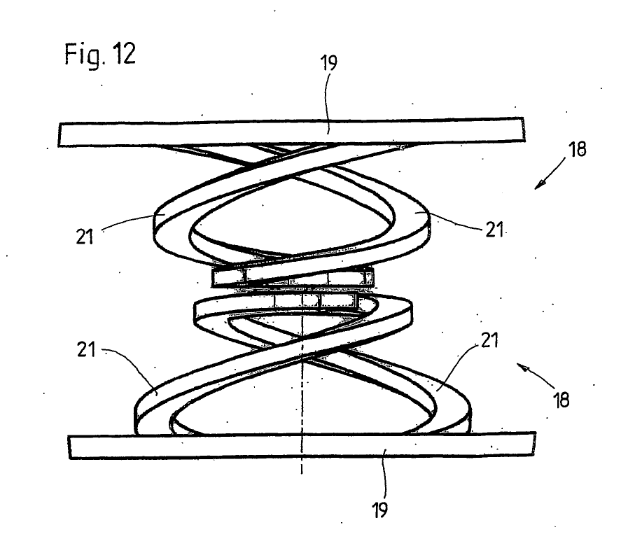

FIG. 12 a spring module according to the invention pursuant to a first embodiment;

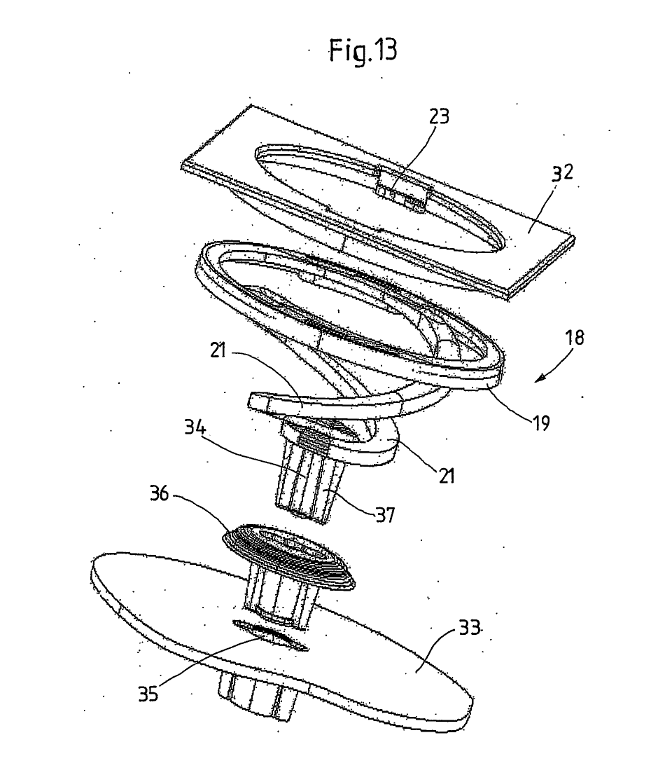

FIG. 13 a spring module according to the invention pursuant to a second embodiment;

FIG. 14 in plan from above, the receiving element according to the invention;

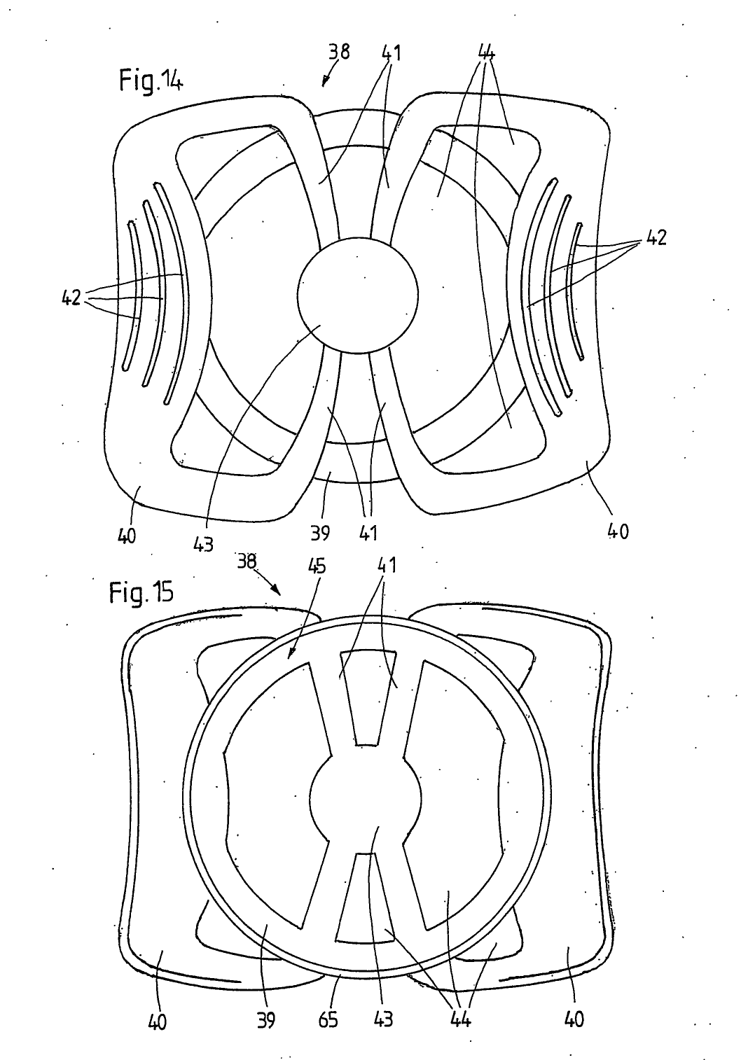

FIG. 15 in plan from below, the receiving element according to the invention;

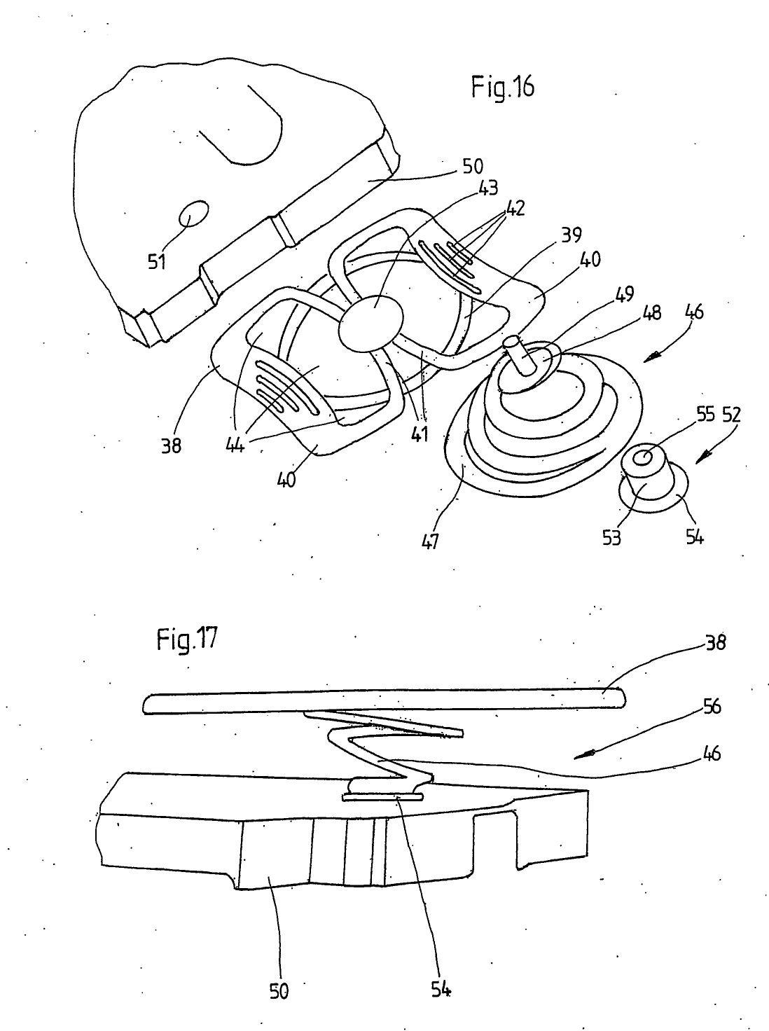

FIG. 16 in a schematic perspective view, the individual components of a support element comprising a receiving element according to the invention;

FIG. 17 in a side view, a support element arranged on a supporting structure, comprising a receiving element according to the invention;

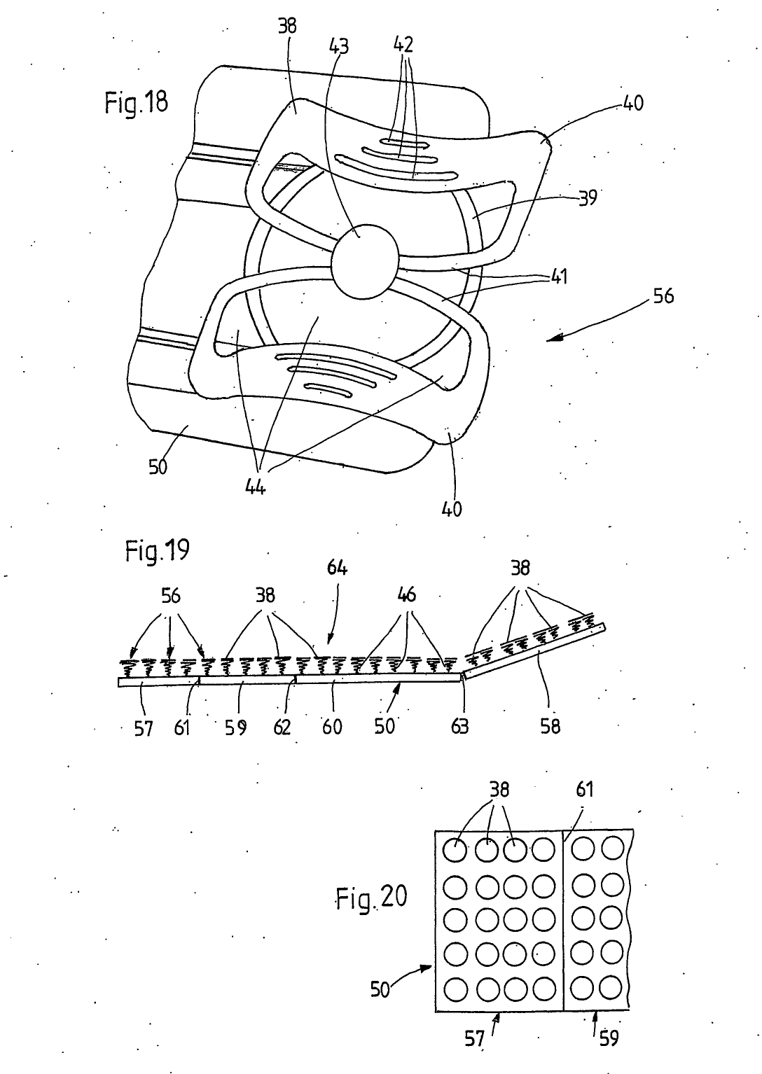

FIG. 18 in a perspective view, the arrangement of a support element on a supporting structure in accordance with FIG. 17, comprising a receiving element according to the invention;

FIG. 19 in a schematic side view, a supporting structure designed as a lying surface of a bed and accommodating several receiving elements according to the invention;

FIG. 20 a schematic cutout view in plan from above according to FIG. 19;

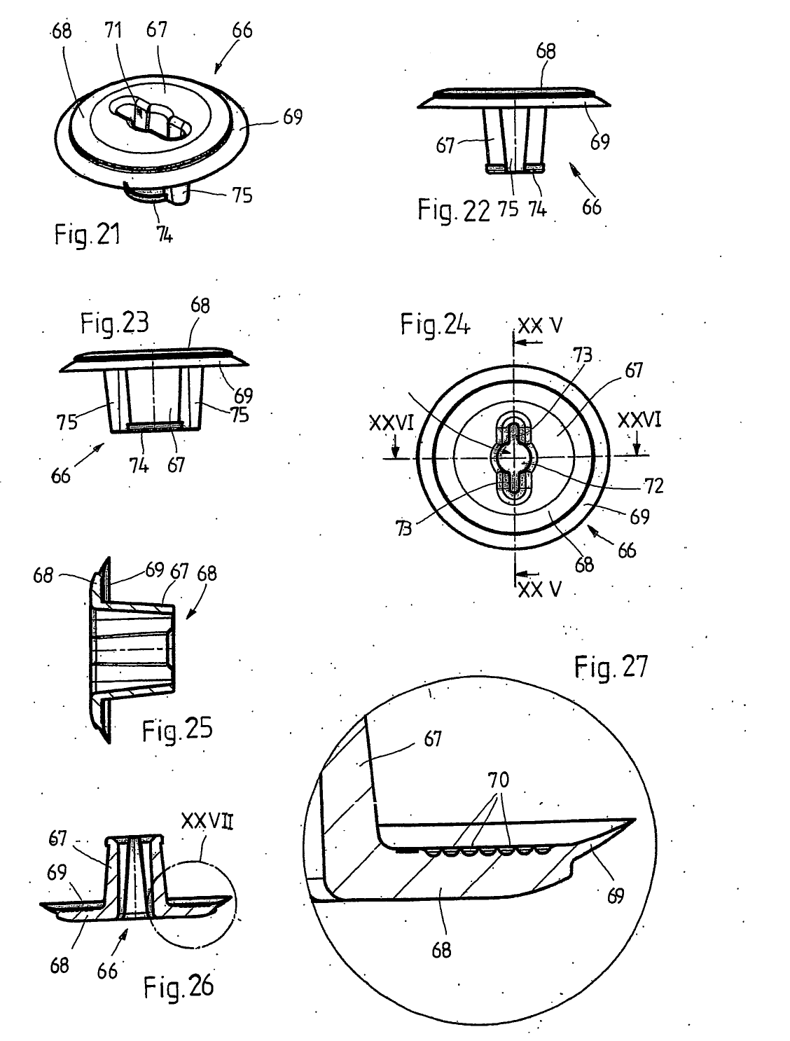

FIG. 21 the connector according to the invention in a schematic perspective view;

FIG. 22 the connector according to the invention in a first side view;

FIG. 23 the connector according to the invention in a second side view;

FIG. 24 the connector according to the invention in plan from above;

FIG. 25 the connector according to the invention in a first sectional view according to section XXV-XXV;

FIG. 26 the connector according to the invention in a second sectional view according to section XXVI-XXVI;

FIG. 27 a cutout view according to FIG. 26;

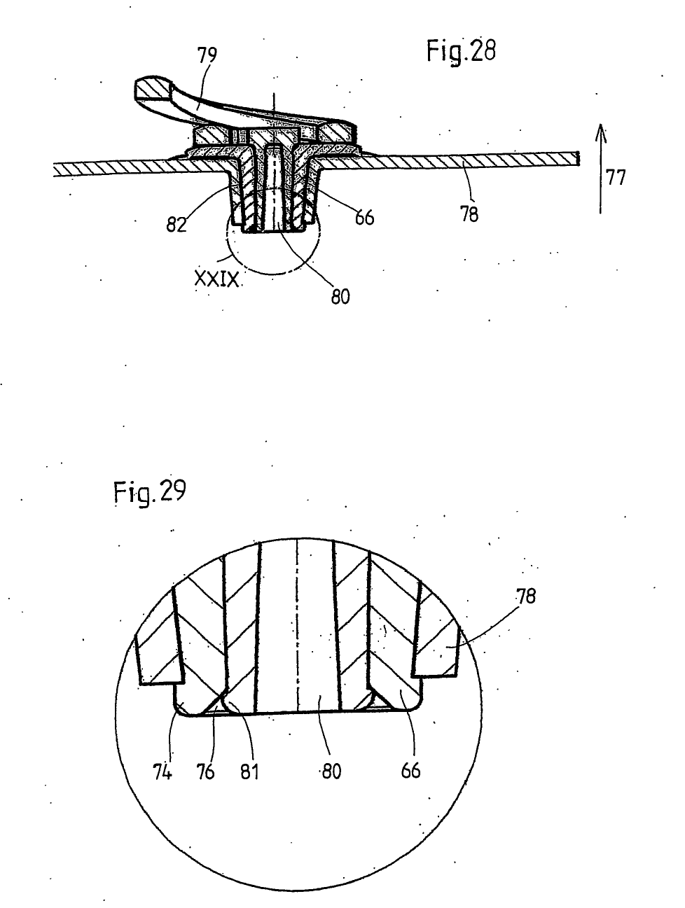

FIG. 28 in a sectioned side view, the arrangement of a functional element on a basis, using the connector according to the invention;

FIG. 29 a cutout view according to FIG. 28;

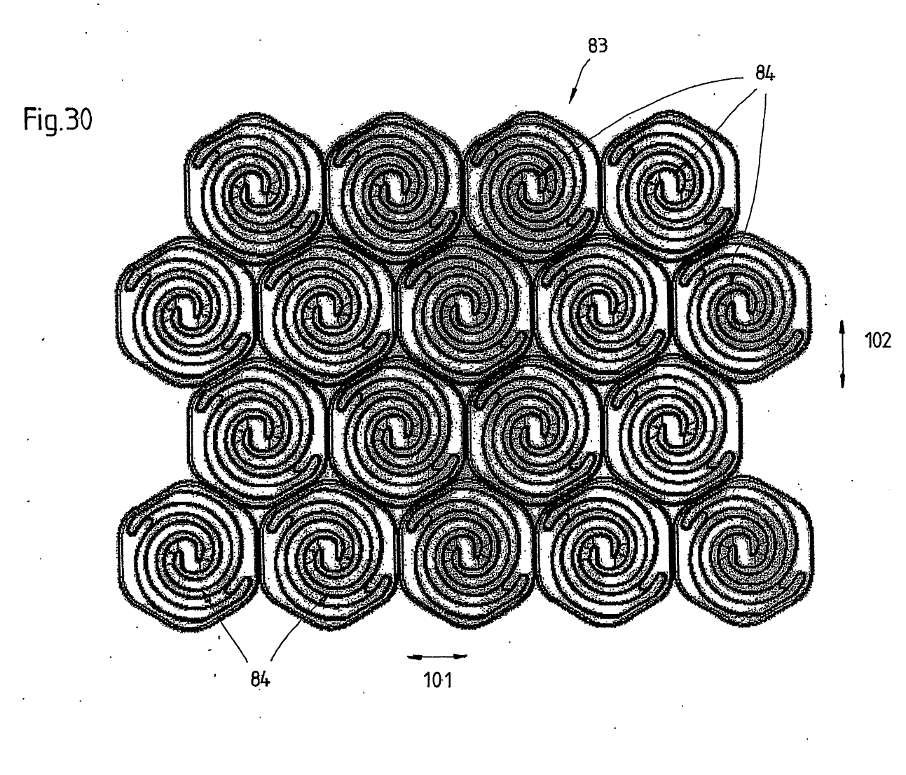

FIG. 30 in a schematic plan from above, the device according to the invention in a first embodiment;

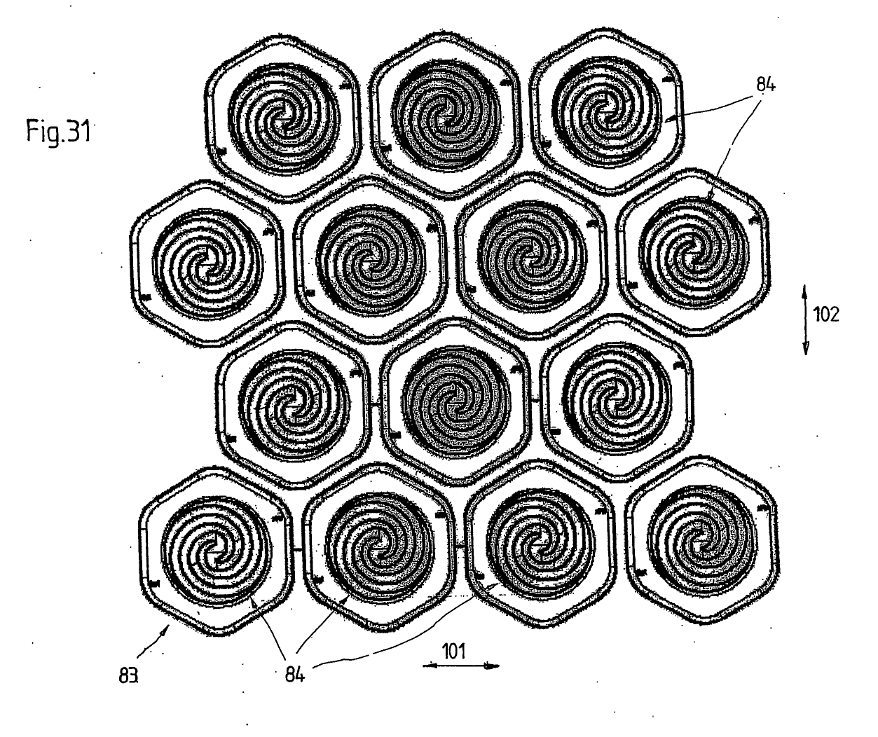

FIG. 31 in a schematic plan from above, the device according to the invention in a second embodiment;

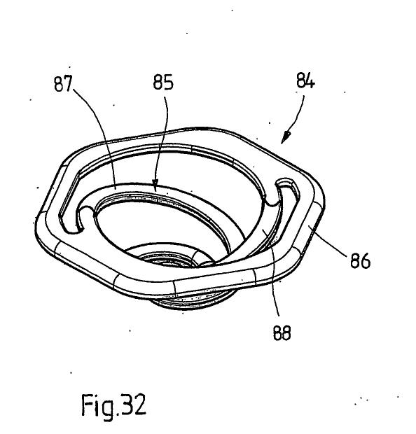

FIG. 32 in a perspective view, a support element of the device according to the invention in a first embodiment;

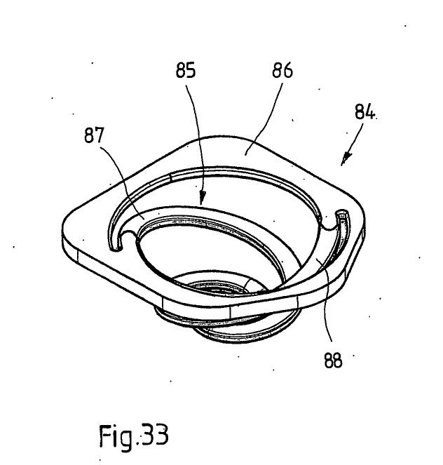

FIG. 33 in a perspective view, a support element of the device according to the invention in a second embodiment;

FIG. 34 in plan from above, a support element of the device according to the invention in a third embodiment;

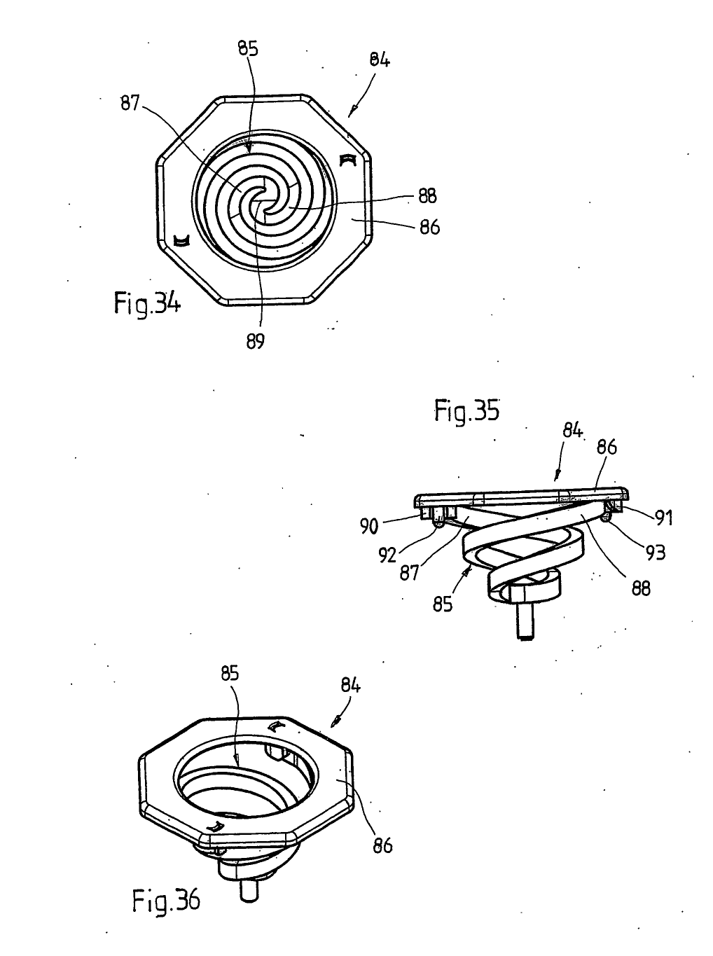

FIG. 35 the support element according to FIG. 34 in a side view;

FIG. 36 the support element according to FIG. 34 in a perspective view;

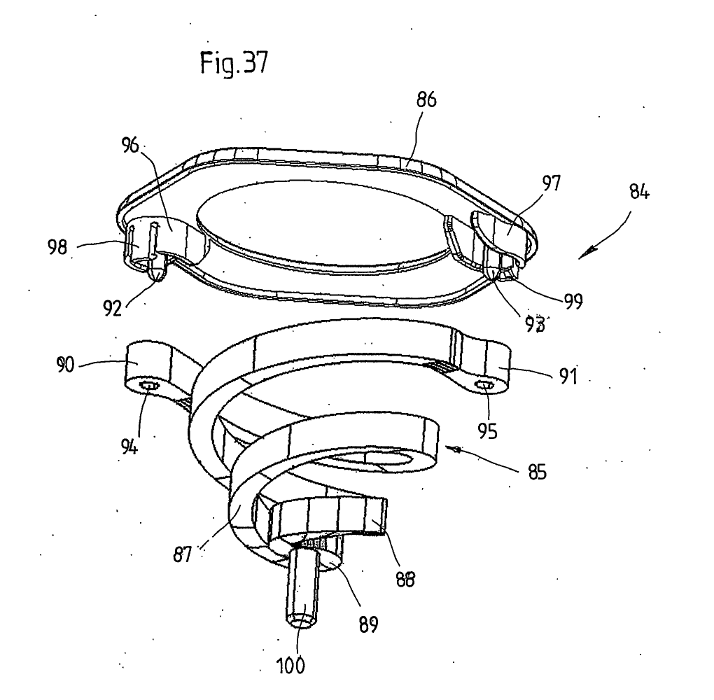

FIG. 37 the support element according to FIG. 36 in an exploded view in a view from below;

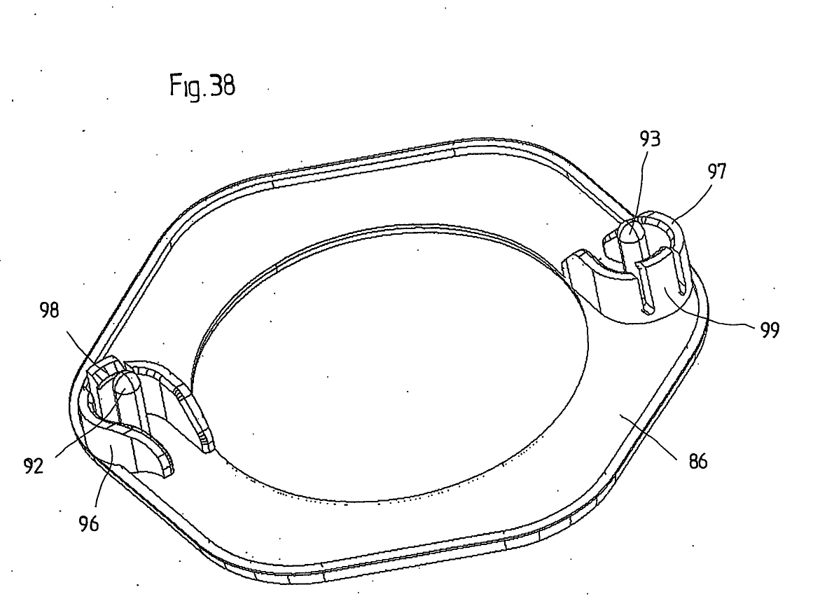

FIG. 38 the pad receptacle of the support element according to FIG. 34 in a perspective view from below;

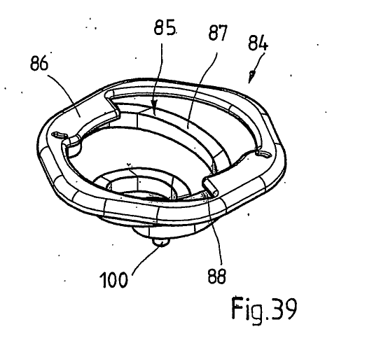

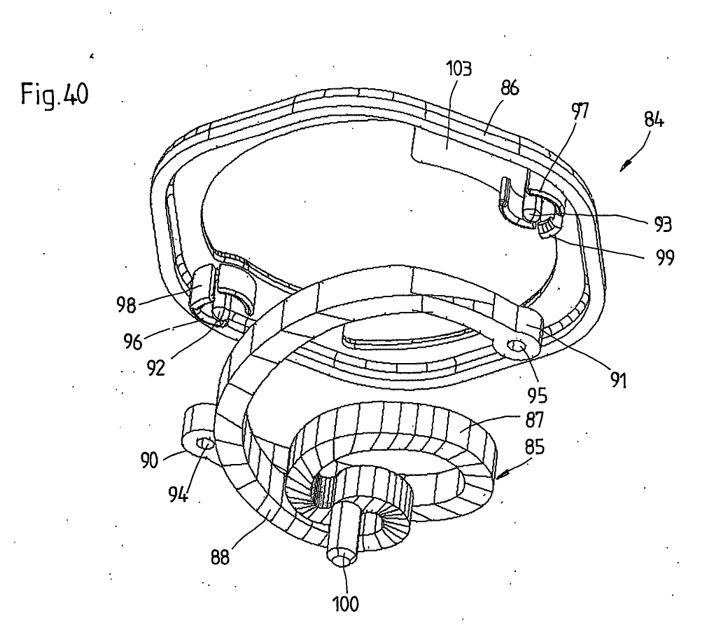

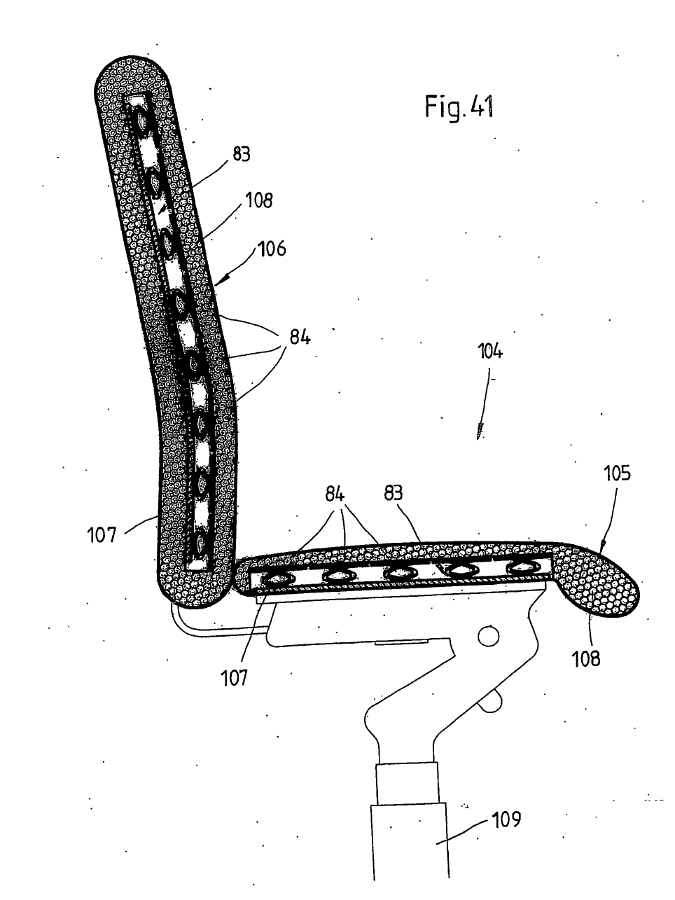

FIG. 39 in a perspective view, a support element of the device according to the invention in a fourth embodiment;

FIG. 40 the support element according to FIG. 39 in an exploded view from below;

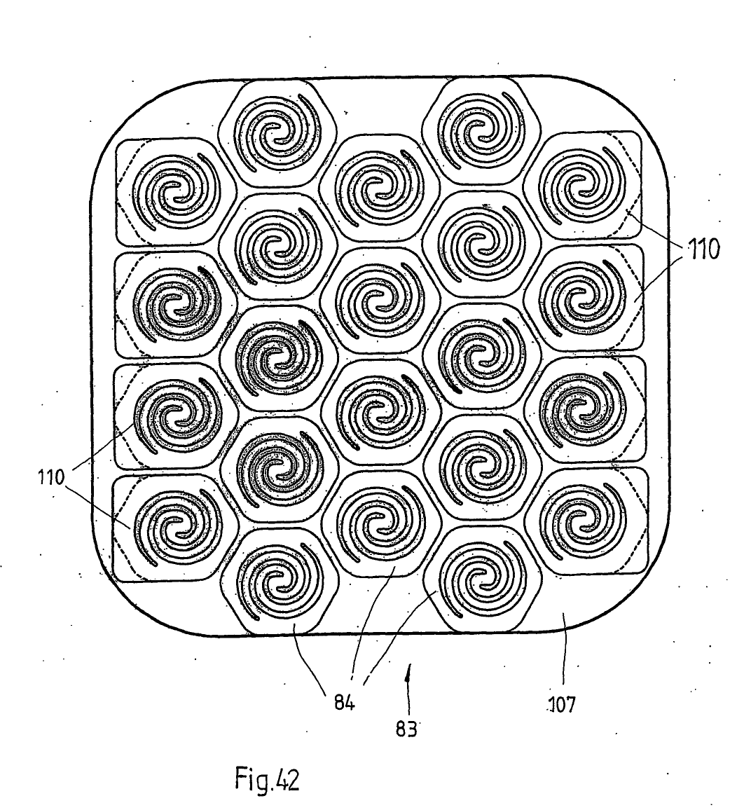

FIG. 41 in a schematic side section view, the use of the device according to the invention illustrated by an office chair, and

FIG. 42 in plan from above, the arrangement of the support elements of the device according to the invention in a first embodiment.

FIG. 1 shows support element 1 in a perspective view in a view from below. The support element is formed by a top plate 2 provided with through-holes 6, a spring element 3 arranged on the top plate 2, and a connecting element 4 arranged opposite top plate 2 on spring element 3.

According to the invention, spring element 3 is formed helically. It extends between top plate 2 of support element 1 on the one hand and a carrier plate 16 accommodating support element 1 on the other hand, as can be gathered in particular from FIGS. 5 and 6. Spring element 3, as is shown in particular in FIG. 5, has a tapered form in the shape of a cone with regard to its cross-sectional area starting from top plate 2 in the direction of carrier plate 16. In the area of the top plate, the spring element preferably has a diameter of 50 mm to 60 mm.

FIG. 2 shows the support element according to the invention in plan from above. The through-holes 6 formed in top plate 2 which serve in particular for ventilating the rest, for instance a mattress, which, in operative condition, is placed on top of support element 1 can be seen clearly.

The individual components of support element 1 according to the invention are shown in FIG. 3. Here, top plate 2, spring element 3, and connecting element 4 can be recognised.

Connecting element 4 is formed in the shape of a plug and comprises a basic body 8 and a circumferential rim 9 arranged thereon. For the purpose of an interchangeable arrangement of support element 1 on a carrier plate 16, connecting element 4 can be inserted interchangeably in a receptacle 17 formed correspondingly in carrier plate 16. Rim 9 of connecting element 4, as can be gathered in particular from FIG. 4, serves to support connecting element 4 against carrier plate 16.

In addition, connecting element 4 has a boring 10 into which the end of spring element 3 which is remote from the top plate can be inserted preferably in an interchangeable manner. In order to ensure a torsion-proof arrangement of support element 1 in relation to carrier plate 16, the connecting element 4 is arranged in a torsion-proof manner both on spring element 3 and on carrier plate 16.

Spring element 3 consists of a helically formed spring body 11, a base part 7 and a pin 12 arranged on base part 7 and formed corresponding to boring 10 of the connecting element. In assembled condition, base part 7 of spring element 3 supports itself against connecting element 4, as can be gathered in particular from FIG. 5.

Top plate 2 consists of a form element 15 which is preferably formed as an injection moulded part. On the side of form element 15 averted from the rest, a receptacle 13 is provided for a torsion-poof arrangement of spring element 3 on top plate 2. With regard to its size, receptacle 13 is dimensioned so as to completely accommodate the last helical thread of spring body 11 of spring element 3. In this manner, a uniform introduction of force via top plate 2 into spring element 3 can be ensured. In order to fasten spring element 3 in relation to top plate 2, receptacle 13 can have connection means 14. These connection means are preferably formed such that an interchangeable arrangement of top plate 2 on the one hand and spring element 3 on the other hand is possible. For instance, the connection means can be formed as latch or clip means.

As already described above, the arrangement of a connecting element 4 in a carrier plate 16 is shown in FIG. 4. In FIG. 4, rim 9 of connecting element 4 resting on carrier plate 16 can be seen clearly. Moreover, boring 10 of connecting element 4 can be seen, into which pin 12 of spring element 3 is to be inserted. FIG. 1 shows the arrangement of connecting element 4 on spring element 3, whereby according to the plan from below shown here, pin end 5 of pin 12 of spring element 3 located in boring 10 can be seen.

FIGS. 5 and 6 show a support element 1 finally assembled on carrier plate 16. Depending on the size of the used carrier plate 16, the latter can be equipped with a plurality of support elements 1, whereby the support elements 1 are preferably arranged in the form of a row on carrier plate 16.

Spring element 18 shown in FIGS. 7 to 11 consists of a top section 19 and a base section 20. Spring arms 21 extend in height direction 27 between top section 19 and base section 20. In total, two spring arms 21 are provided which, starting from base section 20, extend helically up to top section 19. According to the invention, spring element 18 is formed in one piece and consists of plastic.

As can be gathered in particular from FIG. 9, base section 20 is formed in S-shape. It connects the two end areas 30 of the spring arms 21 on the base section side.

As can also be seen in particular from FIG. 9, top section 19 is formed annularly. The spring arms 21 issuing from base section 20 merge into top section 19 on the inner circumference side of the same. The end areas 29 of the spring arms 21 on the top section side are located opposite each other and rest against top section 19.

Starting from top section 19, spring body 22 formed by the two spring arms 21 has a tapered embodiment in the shape of a cone, as can be gathered in particular from the side views of the spring element in FIGS. 7 and 8.

The helical twist of each of the two spring arms 21 is 360°, whereby the end areas 29 of the spring arms 21 on the top section side and the end areas 30 of the spring arms 21 on the base section side are arranged opposite each other on base section 20 and on top section 19, respectively.

It is understood that the embodiment of spring element 18 as described above can be designed according to the respective application requirements. So for instance, a helical twist per spring arm 21 of more or less than 360° can be provided. The spring body 22 can also be formed of more than two spring arms 21. For instance, a three- or four-stranded design can be provided.

Spring element 18 shown in FIGS. 7 to 11 is not represented true to scale. The outer diameter of the annular top section 19 preferably has a size of D_{A}≅11 cm. Depending on the application, different diameter sizes may be provided as well. In height direction 27, spring element 18 preferably has a longitudinal extent of L_{H}≅5 cm. Depending on the application, different longitudinal extents of L_{H}≅ for instance 3 cm to 7 cm are also imaginable.

Spring element 18 according to the invention is characterised by its compact size and the possibility of versatile applicability. It can be used as a resilient base for sitting or lying surfaces of seating furniture and beds, car or lorry seats, garden and camping furniture, massage and other nursing care devices, or the like. It can easily be assembled and disassembled, it is weather-resistant and corrosion-proof and can easily be cleaned using water.

According to a special embodiment of the invention, spring element 18 can be combined with a support surface, for instance in the form of a top plate 32, to be arranged on the top section side, as shown in FIG. 13. For a torsion-proof arrangement of spring element 18 on a top plate, recesses not shown in the Figures can be provided on the outer circumference side of the annular top section 19. In case of an arrangement on a top plate 32, these engage in correspondingly formed retaining grooves of the top plate so as to prevent a relative torsion of spring element 18 in relation to top plate 32. According to a special embodiment of the invention, several spring elements 18 can be arranged on one and the same top plate 32.

Spring element 18 is connected with top plate 32 preferably by means of a so-called bayonet catch. For this purpose, top section 19 has through-holes 24 formed as oblong holes which comprise sections of different cross dimensions in longitudinal direction. As can be gathered in particular from FIG. 10, within the through-holes 24 an undercut 31 is formed in this manner behind which retaining elements 23 formed correspondingly on top plate 32 can engage.

In this way, a force-transmitting connection between spring element 18 and top plate 32 is created which can be released again at any time.

As can also be gathered from FIG. 10, latch means 26 are provided on the bottom side of top section 19 in the area of the through-holes 24. These latch means 26 serve to secure a retaining element 23 inserted into the through-holes 24, thereby preventing an unintended release of the connection between spring element 18 and top plate 32.

Stiffening ribs 25 are arranged on the bottom side 28 of top section 19 for the purpose of reinforcing the same. In the exemplary embodiment according to FIG. 11, three stiffening ribs 25 in total are provided. On the one hand, each through-hole 24 is surrounded by a stiffening rib 25, on the other hand, a stiffening rib 25 is provided in the outer rim area of top section 19.

According to another embodiment of the invention, spring element 18 can be arranged on a supporting structure an example of which is shown in FIG. 13. As supporting structures 33 for the purpose of the invention, all such supporting structures are eligible which can accommodate spring element 18 according to the invention for a use as intended, i.e. which spring element 18 can be arranged on. In this context, for instance lying surface elements, framework constructions, slatted frames, and the like are to be mentioned. Spring element 18 is arranged on the base section side of such a supporting structure 33. For this purpose, base section 20 can be designed with a corresponding connecting element 34, for instance in the form of a pin-shaped extension. Supporting structure 33 comprises a recess 35 formed corresponding to the pin-shaped extension, into which the latter can be inserted. Such an arrangement is preferably accomplished in a torsion-proof manner, which can for instance be achieved in that the pin-shaped extension has a cross-section deviating from the circular form. Of course also different embodiments of the connection between spring element 18 on the one hand and supporting structure 33 on the other hand are imaginable, however, the type of connection described above has been found to be advantageous in that it can be formed and released in an easy manner, reducing the assembly and disassembly effort to a minimum. Moreover, the connection is releasable, such that spring element 18 can be separated from the supporting structure for cleaning purposes as desired. A supporting structure 33 preferably serves for the arrangement of several spring elements 18 which are preferably held in a row and/or symmetrically by supporting structure 33.

According to a preferred exemplary embodiment of the invention, the pin-shaped extension serving as connecting element 34 is inserted into recess 35 of supporting structure 33 by interposing a sleeve-shaped body 36. Such a sleeve-shaped body 36 is shown by way of example in FIG. 13. The sleeve-shaped body 36 is preferably formed of a rubber-elastic material. For the purpose of assembling the spring element 18, the sleeve-shaped body 36 is inserted into recess 35 of the supporting structure 33. Subsequently, spring element 18 is inserted into the sleeve-shaped body 36, with the extension serving as connecting element 34 first. Connecting element 34 has laterally arranged reinforcing ribs which can be designated as bracings 37 (cf. FIG. 8). Both recess 35 and the sleeve-shaped body 36 are formed corresponding to the cross-section of connecting element 34 including the bracings 37 arranged thereon, and have slot-like expansions accommodating the bracings 37, as can be gathered in particular from FIG. 13. When connecting element 34 is inserted into the sleeve-shaped body 36, the latter is spread by the bracings 37 of connecting element 34, resulting in a firm connection between spring element 18 and the supporting structure. In addition, this design ensures that the sleeve-shaped body 36 is arranged in a torsion-proof manner both in relation to connecting element 34 and in relation to recess 35. Moreover, for a positionally stable arrangement of spring element 18 on the supporting structure 33, the sleeve-shaped body 36 preferably formed of elastic material can be pushed into, i.e. pressed into, recess 35. For this purpose, the sleeve-shaped body 36 is slightly overdimensioned in relation to recess 35. What is more, the geometric designs of recess 35 and sleeve-shaped body 36 are matched to each other such that spring element 18 can be assembled or disassembled by normal manual force. The use of any tools is not required.

An exploded view of a spring module consisting of spring element 18 and top plate 32 is shown in FIG. 13. Furthermore, FIG. 13 shows the supporting structure 33 and the sleeve-shaped body 36, which serves to arrange spring element 18 on supporting structure 33.

According to another exemplary embodiment not shown in the figures, spring element 18 can be arranged immediately on a supporting structure 33. According to this exemplary embodiment, base part 20 of the spring element has a recess or boring which a fastening means, for instance a screw or a rivet, can be led though in order to fasten spring element 18 on supporting structure 33. Such a design is suitable for instance to form sitting or lying surfaces of furniture, in particular garden or outdoor furniture. In order to form the sitting or lying surface, a plurality of spring elements 18 is arranged closely side by side on a supporting structure 33, for instance a plate-shaped base or a base consisting of slats, for which purpose the spring elements 18 can be screwed together, riveted, or otherwise connected with the supporting structure 33. According to this embodiment, the top section of the spring elements 18 comprises a comparatively small outer diameter of e.g. 5 cm, such that due to the close arrangement of the spring elements 18, a plane support surface is created. The spring elements 18 are directly covered with cloth resting on the top sections 19 of the spring elements 18 without interposing additional material, as e.g. foamed material. Particularly suitable as cover cloth is an outdoor material which can be cleaned using water. A lying or sitting surface created according to the foregoing exemplary embodiment offers the advantage that it is particularly suited for outdoor application, since it can easily be cleaned and is corrosion-proof. In addition, it is extremely lightweight and can therefore easily be handled. Another advantage on top of that is that, due to the direct covering of the spring elements 18 with a cover material, a ventilated sitting surface is created such that the formation of sweat by the user can be prevented also in case of prolonged sitting or lying activities.

Another spring module according to the invention is shown in FIG. 12. The spring module shown here consists of two spring elements 18 which are connected to each other on the base section side. It is understood that also the two spring elements 18 shown in FIG. 12 can be connected on the top section side with one top plate 32 each according to FIG. 13.

FIGS. 14 and 15 show receiving element 38 according to the invention in isolated position, whereby FIG. 14 shows receiving element 38 according to the invention in plan from above, and FIG. 15 shows receiving element 38 according to the invention in plan from below.

Receiving element 38 according to the invention is formed in one piece and consists of plastic. Receiving element 38 according to the invention is preferably produced by injection moulding.

Receiving element 38 is formed of a circular section 39 on the one hand, as can be gathered in particular from FIG. 15, and two surface sections 40 arranged thereon, on the other hand. As can be seen in particular from FIG. 15, the circular section 39 comprises a receiving area 45 on the side averted from the mattress, the pad, or the like, the function of which will be described subsequently. Receiving area 45 is surrounded by a circumferential collar 65 arranged on the circular section 39, the function of which collar will also be described subsequently.

The circular section 39 and the two surface sections 40 are connected by means of two reinforcing ribs 41, as can be gathered in particular from FIG. 14. A central sector 43 which the reinforcing ribs 41 lead into is arranged within the circular section 39. This factual connection can be gathered both from FIG. 14 and FIG. 15.

Receiving element 38 has through-holes 44 which serve in particular for ventilating a mattress, pad, or the like placed on top of the receiving element.

The structure of the plate-shaped receiving element 38 formed in dish style described above is characterised by its high dimensional stability and torsional stiffness also against bending and/or torsional strains.

On the side facing the mattress, the pad, or the like when used as intended, the surface sections 40 have ribs 42. These ribs not only contribute to additional stabilisation of the receiving element 38, but the ribs 42 also ensure a comparatively secure positioning of the mattress, the pad or the like on receiving element 38, since these ribs 42 help to prevent an undesirable relative displacement between the mattress, the pad, or the like on the one hand and receiving element 38, on the other hand.

According to the invention, receiving element 38 can be arranged interchangeably on a carrier element 46 as is shown for instance in the form of a spring-elastic element in FIGS. 16 and 17. For this purpose, receiving element 38 comprises the aforementioned receiving area 45 on the carrier element side. When assembled, this receiving area 45 accommodates a correspondingly formed section of carrier element 46. For the purpose of a displacement-proof arrangement of receiving element 38 on carrier element 46, receiving area 45 is surrounded by a circumferential collar 65 which prevents a relative displacement between receiving element 38 on the one hand and carrier element 46 on the other hand. For the purpose of a torsion-proof arrangement of receiving element 38 on carrier element 46, latch means formed on receiving element 38, but not explicitly shown in the figures, may be provided. For the purpose of a torsion-proof arrangement, receiving element 38 and carrier element 46 can also be screwed together.

When assembled, receiving element 38 and carrier element 46 form a support element 56, as is shown by way of example in FIG. 17. It can be seen here that support element 56 consisting of receiving element 38 and carrier element 46 is arranged on a supporting structure 50. This arrangement is designed interchangeably, such that both support element 56 can be separated from supporting structure 50, and receiving element 38 can be separated from carrier element 46, as desired. The arrangement of support element 56 consisting of receiving element 38 and carrier element 46 on supporting structure 50 is preferably carried out interposing a connecting element 52. This connecting element 52 is preferably made of a thermoplastic plastic and has the form of a plug, as can be gathered in particular from FIG. 16.

FIG. 16 also shows that carrier element 46, which is for instance designed as a spring element, is formed of a spring body 47, a base part 48, and a pin 49 arranged on base part 48. As already described above, connecting element 52 is formed in the shape of a plug and comprises a basic body 53 and a circumferential rim 54 arranged thereon. For the purpose of an interchangeable arrangement of carrier element 46 on a supporting structure 50, connecting element 52 can be inserted interchangeably into a boring 51 formed correspondingly on supporting structure 50. Rim 54 of connecting element 52, as can be gathered in particular from FIG. 16, serves to support connecting element 52 against supporting structure 50.

Connecting element 52 in turn has a boring 55 into which pin 49 of carrier element 46 can be inserted preferably interchangeably. In order to ensure a torsion-proof arrangement of carrier element 46 in relation to supporting structure 50, connecting element 52 is arranged in a torsion-proof manner both on carrier element 46 and on supporting structure 50.

In the embodiment shown in FIG. 16, the carrier element 46 formed as a spring-elastic element consists of a helically shaped spring body 47, a base part 48, and a pin 49 arranged on base part 48, which is formed corresponding to boring 55 of connecting element 52. In assembled condition, base part 48 of carrier element 46 supports itself against connecting element 52, as can be seen in particular from FIG. 16.

Receiving element 38 consists of a form element preferably formed as an injection moulded part, as already described above. In order to arrange receiving element 38 on carrier element 46, receiving element 38 comprises a receiving area 45 on the side facing carrier element 46. With regard to its size, this receiving area 45 is dimensioned so as to completely accommodate the last helical thread of spring body 47. In this manner, a uniform introduction of force via receiving element 38 into carrier element 46 can be ensured. In order to fasten receiving element 38 in relation to carrier element 46, receiving area 45 can have connection means not shown in the figures. The connection means are formed such that an interchangeable arrangement of receiving element 38 on carrier element 46 is possible.

As already described above, FIG. 17 shows, among other things, the arrangement of a connecting element 52 on a supporting structure 50. The rim of connecting element 52 resting on the upper surface of the supporting structure can be seen clearly. Moreover, it can be seen that carrier element 46 is inserted into connecting element 52 with its pin 49 first, which cannot be seen in FIG. 17.

In two different views, FIGS. 17 and 18 show a carrier element 46 provided with a receiving element 38, which carrier element is finally assembled on a supporting structure 50. Depending on the size of the used supporting structure 50, which can for instance be designed in the form of a lying surface for a bed, as is shown by way of example in FIGS. 19 and 20, the supporting structure can be equipped with a plurality of carrier elements 46 provided with receiving elements 38, whereby the carrier elements 46 are preferably arranged in the form of a row on supporting structure 50.

Such an arrangement is shown in an exemplary manner in FIGS. 19 and 20. A supporting structure 50 which is used for instance as a lying surface can be seen here. The lying surface is accommodated by a framework construction of a bed, in particular a sick- and/or nursing bed, which is not shown in the figures for reasons of clarity. The supporting structure 50 shown here by way of example consists of a foot section 57, a head section 58, a leg section 59, and a pelvis section 60, whereby the individual sections 57, 58, 59, and 60 are arranged relatively pivotably against each other by means of corresponding joints 61, 62, and 63, as is shown by way of example on the basis of head section 58 which, in contrast to the other sections 57, 59, and 60, is in a slightly erected position.

Each of the aforementioned sections 57, 58, 59, and 60 has support elements 56 arranged thereon on the mattress side, whereby each support element 56 has a receiving element 38 and a carrier element 46. In their entirety, the receiving elements 38 arranged side by side form a common support surface 64. As shown in a cutout view in FIG. 20, the receiving elements, i.e. the carrier elements 46 carrying the receiving elements 38, are preferably arranged in rows both in transverse and longitudinal extent.

Furthermore, it can be gathered from FIG. 19, that according to a special embodiment of the invention, support elements 56 are provided in the area of the head section 58 which, in contrast to the support elements of the other sections 57, 59, and 60, show receiving elements 38 each of which is supported by two carrier elements 46.

FIGS. 21 to 27 show the connector 66 according to the invention in a preferred embodiment. FIGS. 28 and 29 show the arrangement of a functional element 79 designed as a spring element on a basis 78 designed as a slatted frame or plate-shaped base. Elements which are the same in the figures are identified by the same reference numerals. It is understood that the representation according to FIGS. 21 to 29 is not true to scale and that the use of a spring element as functional element 79 is only by way of example and is by no means restrictive for the invention.

FIG. 21 shows connector 66 according to the invention in a schematic perspective view. It can be seen that connector 66 is formed of a plug-shaped section 67 which has a collar on its upper end in height direction 77. The collar 68 in turn is provided with a circumferential sealing lip 69 which, when connector 66 is assembled, as is shown by way of example in FIG. 28, rests against the upper side of basis 78.

The plug-shaped section 67 is provided with two reinforcing ribs 75 which are arranged on the outer circumference side of the plug-shaped section 67 and which extend radially outward.

An enlarged cutout view of the collar 68 is shown in FIG. 27. It can be seen here that on the outer circumference side, the collar 68 comprises a sealing lip 69 which rests against the upper side of the basis 78 in the manner described above when connector 66 is assembled. Furthermore, it can be gathered from FIG. 27 that collar 68 comprises sealing lamellas 70 on the side located opposite of the basis 78 in assembled condition. Sealing lip 69 and the sealing lamellas 70 ensure that in case of occurrence of any liquids, the connection area between functional element 79 and basis 78 is sealed. This design is beneficial not only in order to prevent an undesirable escape of liquids, but this design also makes it possible to clean the basis 78, the connector 66, and the functional element 79 by means of water without running the risk that the water used for cleaning will reach the bottom side of the basis.

In order to arrange functional element 79 on basis 78, connector 66 must in a first step be inserted into recess 82 formed on basis 78. For this purpose, recess 82 and plug-shaped section 67 are matched to each other correspondingly with regard to their respective cross-section. The reinforcing ribs 75 arranged on the plug-shaped section 67 serve to arrange the plug-shaped section 67 in a torsion-proof manner in relation to the basis 78 on the one hand, while they reinforce the plug-shaped section 67 both against bending and torsional strains on the other hand, thereby facilitating a positionally accurate insertion of connector 66 into recess 82 formed on basis 78. On the side facing connector 66, functional element 79 has a connecting element 80. This connecting element 80 is inserted into recess 71 of the connector. As a result, a positionally accurate and secure arrangement of the functional element 79 in relation to basis 78 is created. As can be seen in particular from FIGS. 21 and 24, recess 71 of connector 66 is formed such that connecting element 80 can be arranged in a torsion-proof manner within recess 71 of connector 66. For this purpose, it is provided that recess 71 have a first section 72 and two second sections 73, whereby the first section is essentially circular in shape, while each of the two second sections are formed like slots. In assembled condition, expansions formed on connecting element 80 engage in these two sections 72, thereby ensuring a torsion-proof arrangement of functional element 79 in relation to connector 66. In addition, as soon as connecting element 80 is inserted into recess 71 of connector 66, connector 66 is pushed apart by these expansions of connecting element 80. Due to this pushing-apart, the reinforcing ribs 75 of plug-shaped section 67 are pressed apart, thereby creating a particularly secure hold of plug-shaped section 67 within recess 82 formed on basis 68. Therefore, the reinforcing ribs 75 serve three functions: They reinforce plug-shaped section 67, they serve a torsion-proof arrangement of plug-shaped section 67 within recess 82 formed on basis 78 and, due to their pushing-apart, they contribute to a particularly secure hold of connector 66 within recess 82 formed on basis 78.

On its end located opposite of the collar, the plug-shaped section 67 has a latch means 74, which has for instance the form of a circumferential bulge. When connector 66 is assembled, latch means 74 rests against the bottom side of basis 78, as can be gathered in particular from FIG. 29. Due to this arrangement, an unintentional removal of connector 66 from recess 82 formed on basis 78 is prevented. For purposes of disassembly, the end of the plug-shaped section 67 bearing the latch means 74 can be easily compressed and be led through recess 82. The geometric dimensions of latch means 74 and the material properties of plug-shaped section 67 are matched to each other such that the plug-shaped section 67 can be compressed merely by applying finger force, i.e. without the use of any tool.

Furthermore, it can be gathered from FIG. 29 that the plug-shaped section 67 has a circumferential groove 76 on the end located opposite of collar 68. In assembled condition, this groove 76 engages in an undercut 81 formed on connecting element 80; as a result, functional element 79 is fixed positionally stable in relation to connector 66. Functional element 79 can therefore not be released unintentionally from connector 66, whereby an overall positionally stable fixation of functional element 79 in relation to basis 78 is achieved.

Pursuant to the exemplary embodiment according to FIGS. 28 and 29, the functional element 79 is designed as a spring element, whereby FIG. 28 shows a partial section of a spring arm of the spring element. Basis 78 is a supporting structure consisting of plastic which is preferably formed as a deep-drawn lying surface. Connector 66 consists of an elastic material, preferably plastic. For the purpose of arranging the spring element designed as functional element 79 on basis 78, initially connector 66 shown in FIGS. 21 to 27 is inserted into recess 82 on basis 78. In height direction 77, the plug-shaped section 67 has an extent of for instance 2 to 6, preferably 5 cm. The exact dimension of the longitudinal extent depends on the thickness of basis 78 in height direction 77 and the thickness of the dome providing the recess 82, respectively, as shown in FIG. 28. What is decisive is that the plug-shaped section 67 has a longitudinal extent in height direction 77 such that the latch means 74 rest in a locking manner against the bottom side of basis 78 on the one hand, and collar 68 carrying the sealing lip and the sealing lamellas rests in a sealing manner against the upper side of basis 78, on the other hand. When connector 66 is inserted into recess 82 of basis 78, the functional element 79 designed as a spring element is inserted into connector 66, for which purpose the connecting element having the shape of a pin-shaped extension arranged on the connector side of functional element 79 is inserted into recess 71 of connector 66. As a result of the insertion of connecting element 80 into recess 71 of connector 66, connector 66 is slightly pushed apart, as a result of which the reinforcing ribs 75 are pressed against the circumference side of recess 82 of basis 78. What is more, the reinforcing ribs 75, as is shown by way of example in FIGS. 21 and 22, can be formed wedge-shaped. For the purpose of forming a large-surface base for the resilient support of the sitting or lying surface of a piece of sitting or lying furniture, a plurality of functional elements 79 designed as spring elements are arranged on a basis 78. Correspondingly, basis 78 has a plurality of recesses 82, into each of which a connector 66 according to the invention is to be inserted for the purpose of arranging a spring element.

FIG. 30 shows the device according to the invention in accordance with a first embodiment. Device 83 according to the invention for the accommodation of pads for padding sitting and/or lying furniture consists of a plurality of adjacently arranged support elements 84. The pad receptacles 86 of each support element 84 which are to be described subsequently are formed annularly and have an hexagonal outer contour such that the support elements 84 are arranged staggered against each other in transverse direction 102. In longitudinal direction 101, the support elements 84 form a row without any staggering. However, it is understood that a staggered arrangement of the individual support elements 84 is possible also in longitudinal direction 101, for instance when the outer contour of the annular pad receptacles has more than six angles. Any design is imaginable here.

Another exemplary embodiment of the device according to the invention is shown in FIG. 31. Here, too, the device according to the invention is formed by a plurality of support elements 84 arranged adjacent to each other, whereby in contrast to the exemplary embodiment according to FIG. 30, the support elements 1 shown in FIG. 31 are arranged relative to each other leaving a space. The space can be dimensioned depending on the embodiment.

FIG. 32 shows support element 84 in a first embodiment, as it can be applied in accordance with FIGS. 30 and 31 in the device according to the invention. It can be seen that support element 84 consists of a spring element 85 on the one hand and a pad receptacle 86 on the other hand. Spring element 85 in turn is formed of two spring arms 87 and 88 extending helically from a base section 89. Located opposite of base section 89, pad receptacle 86 is arranged on the spring arms 87 and 88, i.e. on spring element 85. In the embodiment according to FIG. 32, the support element 84 is formed in one piece, i.e. spring element 85 forms a one-piece component together with pad receptacle 86.

As can be seen from FIG. 32, pad receptacle 86 is formed annularly and has an hexagonal outer contour, as already explained on the basis of FIGS. 31 and 32. An alternative embodiment is shown in FIG. 33. In contrast to FIG. 32, FIG. 33 shows a support element with a pad receptacle 86 having a pentagonal outer contour. In other respects, support element 84 in FIG. 33 corresponds to support element 84 in FIG. 32.

The support elements 84 according to FIGS. 32 and 33 are preferably combined with each other in order to create a device 83 which is flush on the end sides as is shown by way of example in FIG. 42, which will be explained in more detail in the following.

Support element 84 according to FIGS. 32 and 33, respectively, is formed as a one-piece injection moulded part and consists of plastic. It is particularly easy to care for and corrosion-proof.

FIGS. 34 to 38 show different views of an alternative embodiment of support element 84. This support element 84 as well consists of a spring element 85 on the one hand and a pad receptacle 86 on the other hand. In contrast to the alternative explained above, support element 84 according to FIGS. 34 to 38 is not formed integrally, but spring element 85 and pad receptacle 86 rather consist of separate components which can be combined with each other as desired. The advantage of this embodiment is in particular that spring element 85 and pad receptacle 86 can be made of different materials. However, each of the spring element 85 and the pad receptacle 86 are made of plastic and are formed of injection-moulded parts.

Connection means formed on spring element 85 and on pad receptacle 86 the embodiment of which can be gathered in particular from FIG. 37 serve to connect spring element 85 and pad receptacle 86. As is shown in this Fig., the spring arms 87 and 88 of spring element 85 have a receptacle in the form of an eye 90 and 91, respectively, formed on one end. Each of these eyes 90 and 91 has a through-bore 94 and 95, respectively. Pins 92 and 93 formed corresponding to these through-bores 94 and 95 are arranged on the spring element side of pad receptacle 86, as can be gathered in particular from FIG. 40. In assembled condition, these pins 92 and 93 engage in the bores 94 and 95 of spring element 85, thereby ensuring a positionally stable arrangement of pad receptacle 86 on spring element 85. Each of the pins 92 and 93 of pad receptacle 86 is surrounded by a housing-like receptacle 96 and 97, respectively, which receptacles, in assembled condition of support element 84, accommodate the associated eyes 90 and 91, respectively, of spring element 85. In order to prevent an undesirable separation of spring element 85 and pad receptacle 86, each of the receptacles 96 and 97, respectively, has a latch nose 98 and 99, respectively. In assembled condition of support element 84, these latch noses 98 and 99 engage behind the associated eyes 90 and 91 of spring element 85. The latch noses 98 and 99 are spring-elastic, such that pad receptacle 86 can be separated from the respective associated spring element 85, if required, for instance for cleaning or repair purposes.

FIGS. 39 and 40 show different views of another embodiment of support element 84. The embodiment shown here essentially corresponds to that shown in FIGS. 34 to 38, whereby in contrast to that embodiment, it is provided that the support surfaces 64 formed on pad receptacle 86 for the spring arms 87 and 88 of spring element 85 are only formed in the areas of the receptacles 96 and 97. In contrast to the embodiment explained above, the support surfaces 103 are not formed continuously.

The embodiments explained above have in common that spring element 85 of support element 84 comprises two helically shaped spring arms 87 and 88 and therefore has a two-stranded design. Different embodiments are imaginable as well, for instance spring elements with a three- or four-stranded design. The support elements 84 explained above also have in common that spring element 85 and/or pad receptacle 86 are made of plastic and are formed as injection-moulded parts.

For the purpose of arranging the support elements 84 on a counterpart, for instance a carrier frame, a carrier plate, a supporting frame, an arrangement of slats or the like, each of the support elements 84 has a pin-shaped extension 100 which is preferably formed in one piece with spring element 85 and arranged opposite of pad receptacle 86. The design of this pin-shaped extension 100 is shown by way of example in FIG. 35, 36, 37, 39 or 40. The counterpart not shown in more detail in these figures has borings formed corresponding to the extensions 100, into which the latter can be inserted for the purpose of a positionally stable arrangement of the support elements 84. For the purpose of a torsion-proof arrangement, the pin-shaped extensions 100 preferably have a cross-section deviating from the circular shape. In addition, latch means may be provided which prevent an unintentional removal of the pin-shaped extensions 100 from the borings formed correspondingly on the counterpart.

An exemplary use of the device 83 according to the invention is shown in FIGS. 41 and 42 on the basis of an office chair 104.

As can be gathered from FIG. 41, the office chair 104 has a stand 109 carrying both a seat surface 105 and a back surface 106. The support elements 84 described on the basis of the foregoing figures serve as a padding of the pad material 108 both of the seat surface 105 and of the back surface 106, whereby the support elements 84 of back surface 106 form a first device 1 according to the invention, and the support elements 84 of the seat surface 105 form a second device 83 according to the invention.

In the schematic sectional view according to FIG. 41, it can be seen that the support elements 84 both of the seat surface 105 and of the back surface 106 are mounted on a carrier plate 107. This carrier plate 107 serves to support the support elements 84 arranged thereon, whereby for connecting carrier plate 107 and support elements 84, it may be provided that carrier plate 107 has borings into which the pin-shaped extensions 100 of the support elements 84, which are not shown in FIG. 41 for reasons of clarity, are inserted. As an alternative to this embodiment, it may also be provided that the support elements are screwed together with, riveted, or glued on, or otherwise connected with the associated carrier plate 107. What is solely decisive for the invention is that the support elements 84 of seat surface 105 and the support elements 84 of back surface 106, respectively, together form a device 83 according to the invention serving for the accommodation, i.e. padding, of pad material 108.

As can easily be gathered from FIG. 41, by the devices 83 according to the invention, a volume space is formed underneath the respective associated pad material 108, both with regard to the seat surface 105 and with regard to the back surface 106. This volume space serves in a beneficial manner for ventilating the pad material 108, which clearly improves the sitting comfort in particular during prolonged sitting. Another advantage of the device 83 according to the invention is that the respective associated support elements 84 can be formed of spring elements 85 providing varying resilience properties. So it may for instance be provided that the spring elements of seat surface 105 are much stiffer than the spring elements 85 of the back surface 106. In addition, it may be provided that the spring elements both within seat surface 105 and within the back surface 106 have varying resilience properties. It may for instance be provided that the device 83 of seat surface 105 comprises support elements 84 in the central area, the spring elements of which are stiffer than the spring elements of the support elements in the edge area of the device 83. Varying loads applied to the seat surface 105 which are due to the normal sitting position of a sitting person are thereby taken into account.

FIG. 42 shows by way of example the arrangement of the spring elements 85 on carrier plate 107 illustrated by seat surface 105 in a view from above. As can be seen here, the support elements 84 are arranged in rows staggered against each other, whereby the pad receptacles of the support elements 84 have an hexagonal outer contour. In order to form a flush edge of device 83, also pentagonally formed pad receptacles 86 instead of hexagonal pad receptacles can be inserted on the edge side, as is shown by way of example by means of the support elements 110 in FIG. 42.

### LIST OF REFERENCE NUMERALS

1 Support element 43 Central sector
2 Top plate 44 Through-hole
3 Spring element 45 Receiving area
4 Connecting element 46 Carrier element
5 Pin end 47 Spring body
6 Through-holes 48 Base part
7 Base part 49 Pin
8 Basic body 50 Supporting structure
9 Rim 51 Boring
10 Boring 52 Connecting element
11 Spring body 53 Basic body
12 Pin 54 Rim
13 Receptacle 55 Boring
14 Connection means 56 Support element
15 Form element 57 Foot section
16 Carrier plate 58 Head section
17 Receptacle 59 Leg section
18 Spring element 60 Pelvis section
19 Top section 61 Joint
20 Basic section 62 Joint
21 Spring arm 63 Joint
22 Spring body 64 Support surface
23 Retaining element 65 Collar
24 Through-hole 66 Connector
25 Stiffening rib 67 Plug-shaped section
26 Latch means 68 Collar
27 Height direction 69 Sealing lip
28 Bottom side 70 Sealing lamella
29 End area 71 Recess
30 End area 72 First section
31 Undercut 73 Second section
32 Top plate 74 Latch means
33 Supporting structure 75 Reinforcing rib
34 Connecting element 76 Groove
35 Recess 77 Height direction
36 Sleeve-shaped body 78 Basis
37 Bracing 79 Functional element
38 Receiving element 80 Connecting element
39 Circular section 81 Undercut
40 Surface section 82 Recess
41 Reinforcing rib 83 Device
42 Rib 84 Support element
85 Spring element 101 Longitudinal direction
86 Pad receptacle 102 Transverse direction
87 Spring arm 103 Support surface
88 Spring arm 104 Office chair
89 Basic section 105 Seat surface
90 Eye 106 Back surface
91 Eye 107 Carrier plate
92 Pin 108 Pad material
93 Pin 109 Stand
94 Through-bore 110 Support element
95 Through-bore
96 Receptacle
97 Receptacle
98 Latch nose
99 Latch nose D_{A}=Outer diameter
100 Pin-shaped extension L_{H}=Longitudinal extent in height direction

1. A support element, comprising a top plate and a spring element arranged thereon, whereby the spring element is formed helically and in the shape of a cone, wherein the top plate is formed of plastic, the spring element is formed of plastic, and the spring element has a multiple-stranded design.

2. A support element according to claim 1, wherein the spring element is arranged interchangeably on the top plate.

3. A support element according to claim 1, wherein a connecting element which, for the purpose of fastening said spring element on a carrier plate, is arranged on said spring element opposite of the top plate.

4. A carrier plate for the arrangement of a support element according to claim 1, wherein the carrier plate is formed such that it can be connected with said support element, for which purpose the carrier plate has a receptacle formed corresponding to the connecting element of the support element and wherein the carrier plate is made of plastic.

5. A spring element comprising at least two spiral and/or helically shaped strip elements of plastic and formed as injection moulded parts, whereby the strip elements interact in such a way that they give resiliently when force is applied, whereby the spring effect of the strip elements can be predetermined by a suitable choice of geometry and/or material.

6. A spring element comprising two spiral or helically shaped strip elements formed as spring arms, a base section, and a top section located opposite of the base section in height direction, whereby each of the base section, the top section, and the spring arms are made of plastic and are formed as injection moulded parts.

7. A spring element according to claim 6, wherein the top section comprises stiffening ribs on its bottom side facing the base section.

8. A spring element according to claim 6, wherein the spring body formed by the spring arms, starting from the top section, has a tapered form in the shape of a cone.

9. A spring module formed of a spring element according to claim 6, and a top plate arranged on the top section side of the spring element.

10. A receiving element for the at least area-wise accommodation of a mattress, a pad or the like, comprising several receiving elements arranged side by side form a common support surface, wherein it is plate-shaped in dish style and has means for a detachable arrangement on a carrier element.

11. A receiving element according to claim 10, wherein it is formed in one piece and consists of plastic.

12. A receiving element according to claim 10, wherein it comprises a circular section on the one hand and a surface section arranged thereon, on the other hand.

13. A receiving element according to claim 10, wherein the surface section has ribs on the side facing the mattress, the pad, or the like.

14. A connector for the arrangement of a functional element on a basis, with a plug-shaped section, which can be inserted into a recess formed on the basis, for which purpose the plug-shaped section is formed corresponding to the recess of the basis, whereby the plug-shaped section in turn comprises a recess to accommodate a connecting element arranged on the functional element.

15. A connector according to claim 14, wherein the plug-shaped section comprises reinforcing ribs on its outer circumference side which are extending radially outward.

16. A connector according to claim 14, wherein the plug-shaped section has a collar on the other end which, in mounted condition of the connector, rests against the upper side of the basis.

17. A connector according to claim 16, wherein the collar comprises a sealing lip.

18. A connector according to claim 16, wherein the collar comprises sealing lamellas on its bottom side facing the basis.

19. A device for the accommodation of pads for padding sitting and/or lying furniture, with a plurality of support elements arranged adjacent to each other, whereby each support element comprises a spring element and a pad receptacle arranged thereon, whereby the spring element has a multiple-stranded design and comprises at least two spiral and/or helically shaped spring arms and whereby the spring element consists of plastic.

20. A device according to claim 19, wherein the pad receptacle consists of plastic.

21. A device according to claim 19, wherein the pad receptacle is formed polygonally, preferably pentagonally or hexagonal.
